(19) United States
(12) Patent Application Publication
(10) Pub. No.: US 2026/0236991 A1
(43) Pub. Date: Aug. 13, 2026

(54) AI-DRIVEN SYSTEM FOR RISK INTELLIGENCE, ALTERNATIVE CREDIT SCORING, BEHAVIORAL DECISIONING, AND FEDERATED PRIVACY-PRESERVING MODELING

(71) Applicant: Blue Clover, LLC, Woodside, CA (US)

(72) Inventor: Cortland Bohacek, Woodside, CA (US)

(21) Appl. No.: 19/075,592

(22) Filed: Mar. 10, 2025

Related U.S. Application Data
(60) Provisional application No. 63/757,020, filed on Feb. 11, 2025.

(51) Int. Cl. G06Q 10/0635; G06F 8/65; G06Q 40/06; H04L 9/40

(52) U.S. Cl. CPC G06Q 40/06; G06F 8/65; H04L 63/0428

(57) ABSTRACT

A method and system for training artificial intelligence (AI) models is disclosed. The method includes collecting real-time financial risk data from a plurality of institutions without sharing raw data, encrypting the collected data and training a local AI model at each institution to get a local model update for the local AI model, transmitting the local model update from each institution to a central aggregator coupled to a global AI model, training the global AI model based on the local model update received from each institution to obtained the trained AI model, and redistributing the trained AI model back to each of the plurality of institutions for risk assessment.

### CROSS-REFERENCE TO RELATED APPLICATION

This application claims the benefit of U.S. Provisional Patent Application No. 63/757,020, filed on Feb. 11, 2025, the entire content of which is incorporated by reference herein.

### TECHNICAL FIELD

This disclosure generally relates to the field of AI-driven risk assessment, credit decisioning, financial intelligence, and fraud detection systems, and more specifically, to a privacy-preserving federated learning system for multi-institutional risk modeling and decision automation.

### BACKGROUND

Financial risk assessment remains constrained by institutional data silos, preventing financial institutions from collaborating to improve risk models. Each institution independently collects and analyzes proprietary financial data to build its own AI-driven risk assessment models. However, financial activities, such as transactions, credit usage, and behavioral spending patterns, frequently span multiple institutions. Because these AI models are trained on incomplete, fragmented datasets, they struggle to generalize across different financial ecosystems. This results in inconsistent credit decisions, limited predictive accuracy, and increased systemic financial risk. One lender may classify a borrower as high-risk, while another, using a different dataset, may approve the same borrower on more favorable terms. Without a secure, standardized AI-driven framework for risk intelligence, institutions lack visibility into cross-institutional financial behaviors, leading to inequitable lending decisions, increased fraud exposure, and missed opportunities for early risk detection.

Traditional AI-driven risk assessment models fail to address the core issue of secure AI model sharing across financial institutions. Existing frameworks rely on centralized architectures, requiring institutions to transfer raw financial for joint AI model training. However, this approach raises significant security, competitive, and regulatory concerns. Many financial institutions are unwilling or unable to share raw customer data due to proprietary risks, cybersecurity threats, and strict compliance obligations. As a result, AI models remain confined to institution-specific datasets, hindering their ability to detect systemic risks that extend beyond a single financial entity. The absence of a collaborative, privacy-preserving AI framework prevents the development of more robust and adaptive risk intelligence systems.

In addition to data fragmentation challenges, traditional AI-driven risk models often require centralized data aggregation, introducing significant security vulnerabilities and regulatory compliance challenges. Centralized architectures store vast amounts of sensitive financial data in a single system, making them prime targets for cyberattacks. Large-scale data breaches in financial institutions have demonstrated that the risk of unauthorized access increases with centralized storage models, exposing institutions to regulatory penalties, reputational damage, and financial losses. Moreover, centralized AI models increase operational costs, as financial institutions must implement complex security infrastructures to safeguard customer data.

Beyond cybersecurity risks, centralized AI architectures struggle to comply with evolving financial data protection regulations, such as the General Data Protection Regulation (GDPR) in Europe and the California Consumer Privacy Act (CCPA) in the United States. These laws impose stringent restrictions on how financial data is collected, stored, processed, and shared. Many existing AI-driven risk models lack the necessary privacy safeguards, anonymization techniques, and consumer consent mechanisms required for compliance. As financial institutions seek to leverage AI for advanced risk modeling, they face increasing difficulty in balancing AI-driven innovation with strict legal obligations. Without a privacy-preserving approach to AI-powered risk intelligence, financial institutions are constrained in their ability to develop equitable, explainable, and compliant risk assessment frameworks.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

According to some embodiments, a system includes a remote server having a processor and storage; and a plurality of processing devices each having a second processor and a second storage, where the remote server collects raw financial risk data through a processing device of a financial institution, where the financial institution does not share the raw financial risk data with other processing devices of the plurality of processing devices; a local AI model at the processing device of the financial institution is trained based on the raw financial risk data collected by the financial institution, to obtain a local AI model update; the processing device encrypts the local AI model update and transmits the encrypted local AI model update to the remote server having a remote central aggregator associated with a global AI model; the remote server receives other encrypted local AI model updates from the other processing devices, and trains the global AI model based on the encrypted local AI model update from the financial institution and the received other encrypted local AI model updates to generate a global AI model update; the processing device receives the global AI model update distributed to the processing device and update the locally trained AI model on the processing device based on the global AI model update; and the processing device detects a real-time high-risk transaction behavior of a customer of the financial institution using the locally updated AI model.

The foregoing is a summary and thus contains, by necessity, simplifications, generalizations and omissions of detail; consequently, the summary is illustrative only and is not limiting in any way. Other aspects, inventive features, and advantages of the systems and/or processes described herein will become apparent in the non-limiting detailed description set forth herein.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram illustrating a system architecture of an AI-driven risk assessment system, according to some embodiments.

FIG. 2 is a block diagram illustrating example components included in an AI-driven risk assessment engine, according to some embodiments.

FIG. 3A is a block diagram of an example system architecture of a privacy-first federated learning unit, according to some embodiments.

FIG. 3B is a flowchart illustrating an example method for training AI models through an AI-driven decision pipeline of the privacy-first federated learning unit, according to some embodiments.

FIG. 3C is a schematic diagram illustrating an AI model training across a number of institutions, according to some embodiments.

FIG. 4A is a block diagram of an example system architecture of a microeconomic finance scoring unit, according to some embodiments.

FIG. 4B is a flowchart illustrating an example method for processing financial data through an AI-driven decision pipeline of the microeconomic finance scoring unit, according to some embodiments.

FIG. 4C is a flowchart illustrating an example method for applying time-weighted risk adjustment in AI-driven risk assessment, according to some embodiments.

FIG. 5A is a block diagram of an example system architecture of a resilience adjustment financial index unit, according to some embodiments.

FIG. 5B is a flowchart illustrating an example method for processing financial data through an AI-driven decision pipeline of the resilience adjustment financial index unit, according to some embodiments.

FIG. 6A is a block diagram of an example system architecture of a microeconomic intelligence unit, according to some embodiments.

FIG. 6B is a flowchart illustrating an example method for processing financial data through an AI-driven decision pipeline of the microeconomic intelligence unit, according to some embodiments.

FIG. 7A is a block diagram of an example system architecture of a financial stress signal detection unit, according to some embodiments.

FIG. 7B is a flowchart illustrating an example method for processing financial data through an AI-driven decision pipeline of the financial stress signal detection unit, according to some embodiments.

FIG. 8A is a block diagram of an example system architecture of a proactive behavior intervention unit, according to some embodiments.

FIG. 8B is a flowchart illustrating an example method for processing financial data through an AI-driven decision pipeline of the proactive behavior intervention unit, according to some embodiments.

FIG. 9 is a block diagram of an example computer system for implementing the technology described herein, according to some embodiments.

### DETAILED DESCRIPTION

The figures (FIGS.) and the following description relate to some specific embodiments by way of illustration only. It should be noted that from the following descriptions, alternative embodiments of the methods and systems disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed systems or methods for purposes of illustration only. One skilled in the art will readily recognize from the following descriptions that alternative embodiments of the structures and methods illustrated herein may be employed without departing from the principles described herein.

As described earlier, traditional financial risk assessment models face significant technical limitations that hinder their ability to accurately provide credit scoring, fraud detection, and lending decisions.

To address the issue of data silos and the lack of AI model sharing across institutions, the method and system disclosed herein implements federated learning (FL), a decentralized AI training technique that enables financial institutions to collaborate on AI-driven risk assessment without exchanging raw customer data. Unlike traditional centralized AI models, which require financial entities to transfer sensitive records to a central repository, FL allows institutions to train AI models locally on their own datasets while only sharing encrypted model updates with a central AI aggregator. This ensures that customer financial data remains private and secure, eliminating the risks associated with direct data sharing.

Federated learning enhances financial risk assessment by creating a standardized yet privacy-preserving AI framework that improves risk modeling accuracy across multiple institutions. By allowing AI models to be trained on a more diverse set of financial behaviors across different institutions, FL ensures better generalization and fairness in credit risk evaluation. Borrowers who previously received inconsistent credit assessments across lenders can benefit from a more uniform and reliable creditworthiness evaluation. Additionally, FL significantly strengthens fraud detection mechanisms, as fraudulent financial activities that span multiple institutions can now be identified without compromising data privacy. Financial institutions can collaboratively train AI models to recognize cross-institutional fraud patterns, allowing for real-time, AI-driven risk mitigation.

Beyond improving AI model accuracy and fraud detection, federated learning may also ensure compliance with data privacy regulations such as GDPR and CCPA by eliminating the need for direct data transfers between institutions. This addresses the legal and security challenges associated with centralized AI models, which are prone to cybersecurity threats and unauthorized access. FL also enhances regulatory transparency, as financial regulators can audit AI model performance without requiring access to raw customer data. By shifting from a centralized to a decentralized AI architecture, financial institutions can maintain regulatory adherence while unlocking AI-driven innovation in risk assessment.

Additionally, the method and system disclosed herein leverages advanced encryption techniques, differential privacy, and secure multi-party computation to ensure that AI-driven risk models operate within a fully compliant and secure environment. Differential privacy ensures that no individual user's financial data can be reverse-engineered from the AI model, while secure multi-party computation allows multiple institutions to compute shared risk insights without exposing confidential information. These security measures prevent cyber threats, unauthorized data breaches, and regulatory violations, making AI-driven financial risk assessment both scalable and secure.

By integrating federated learning and advanced privacy-preserving AI techniques, the method and system disclosed herein provide a next-generation financial risk assessment system that eliminates data silos, security risks, and regulatory compliance challenges. Financial institutions can now collaborate on AI-driven credit risk modeling, fraud detection, and financial wellness solutions while ensuring data privacy, security, and compliance with global regulations.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### System Overview

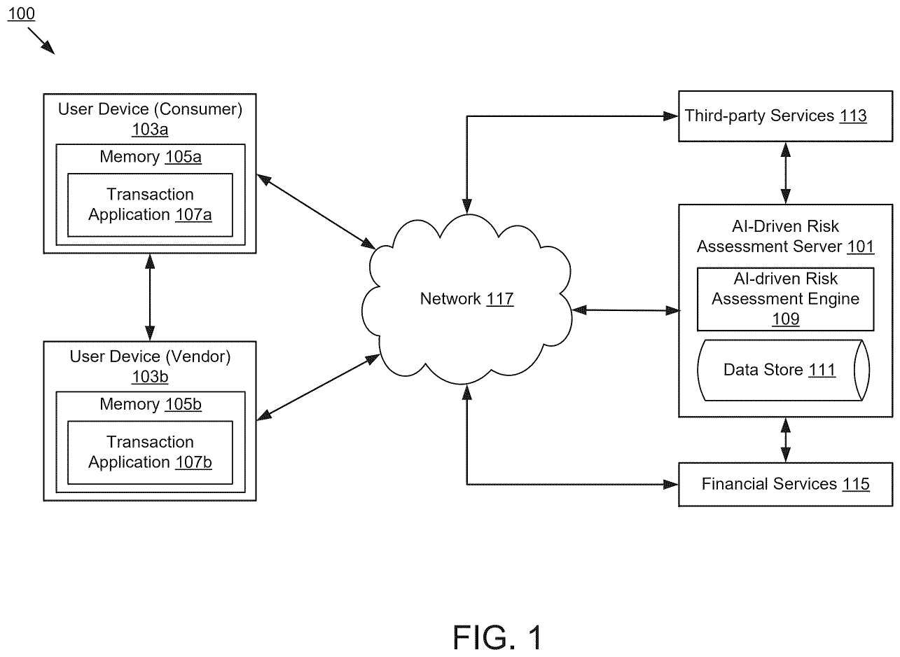

FIG. 1 illustrates an example system architecture of the disclosed risk management system 100, according to some embodiments. The system 100 may be configured to assess risks associated with online transactions, electronic transactions and the like and their participants while maintaining data security and regulatory compliance. It includes computing infrastructure such as servers that may be deployed locally or distributed, handling various functions such as web hosting, data storage, application processing, and financial risk assessment.

The system 100 consists of several key components, including an AI-driven risk assessment server 101, financial services 115 (including parties/devices providing such services, e.g., a processing device associated with an financial institution), third-party services 113 (including parties/devices providing such services), a user device 103a associated with a consumer, a user device 103b associated with a vendor, all of which communicate with each other through a network 117.

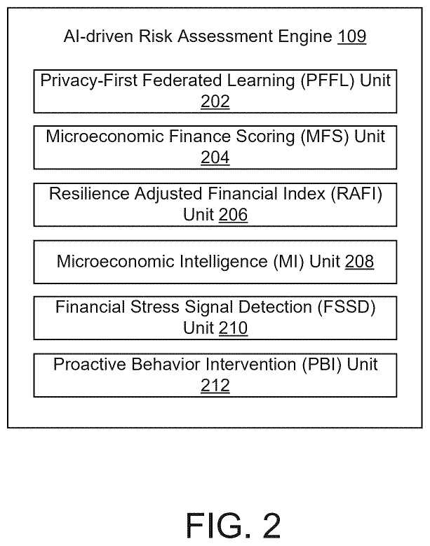

The AI-driven risk assessment server 101 (e.g., a processing device associated with the system 100) includes an AI-driven risk assessment engine 109 and a data store 111 coupled to the engine to store data collected and processed by the engine. The AI-driven risk assessment engine 109 may evaluate potential threats to financial transactions by analyzing vendor and consumer data. It may retrieve transaction histories, credit information, behavioral attributes, and other related information and user activities from the data store 111, third-party services 113, and financial services 115. Using artificial intelligence (AI) models, it may assign a risk score to an online transaction and/or categorize a customer or an activity to be one of high, medium, or low risk, thereby helping determine whether to approve, flag, or decline the transactions and/or adjust credit limits for customers, among others. In one example, if a transaction exceeds a predefined risk threshold, the system 100 may block the transaction or notify relevant financial services 115 in real time via an alerting mechanism (e.g., API callback) so that the potential risk can be minimized. It should be noted that while only one AI-driven risk assessment engine 109 is illustrated in FIG. 1, in some embodiments, the engine 109 may be distributed across multiple different locations, such as financial institutions implementing distinct AI risk assessment components that contribute to a federated AI model, which each organization may implement partial or full functions of the AI-driven risk assessment engine 109. The specific functions of the AI-driven risk assessment engine 109 are further described in detail in FIGS. 2-8B.

The data store 111 may securely store financial and transaction data, including vendor details, merchant terminal data, consumer profiles, records of interactions, fraud indicators, historical payment behaviors, or any activities from customers or organizations. In some embodiments, the data store 111 may organize information using relational structures, enabling efficient querying and risk assessment. The database maintains historical transaction records, risk scores, and consumer financial profiles, and the like which the AI-driven risk assessment engine 109 may use to enhance decision-making and fraud detection. In some embodiments, the data store 111 may be distributed across different locations such as different organizations, where these different databases may be isolated through encryption and access control mechanisms to keep the data privacy associated with different organizations.

Financial services 115 may include banks, credit card companies, mortgage companies, and online payment platforms that process various online or electronic transactions. The system 100 communicates with these institutions through application programming interfaces (APIs), sending payment requests and verifying fund transfers. For instance, when a consumer 103a pays via a bank transfer, the system 100 may confirm fund availability before completing the transaction.

The financial service 115 may be online services that facilitate financial transactions. Vendors 103b may establish accounts with the financial services 115 to manage financial operations efficiently. During a transaction, consumers 103a may provide payment details or customer financial profiles, which are processed through the vendor's terminal and sent to the financial services 115. Financial services 115 may apply AI-driven fraud detection algorithms to validate the legitimacy of a transaction request before forwarding payment or other financial requests to financial institutions for validation, fund transfers, or loan/credit approval. If approved, a payment confirmation is sent to the vendor 103b, or a disbursement or credit approval is released to the customer 103a. The system 100 may also manage vendor accounts, including opening, modifying, or suspending them as needed based on risk evaluations or compliance reviews.

The vendors 103b in the system 100 may be businesses of various types, including but are not limited to banking & financial services, insurance, public policy & government, FinTech & digital payments, healthcare & medical financing, real estate & mortgage lending, retail & consumer finance, wealth management & investment management, etc. Vendors enrolled in the financial services 115 may process financial transactions using transaction terminals, which may include point-of-sale (POS) systems, mobile devices, or other digital interfaces. These terminals may facilitate transaction data entry and payment processing through the system 100. In some embodiments, vendor and consumer devices 103a and 103b may include transaction application 107a/107b stored in the local memory 105a/105b, through which online transactions may be conducted with authentication mechanisms such as biometric verification or multi-factor authentication.

Consumers 103a may interact with vendors 103b either in person or through network 117, using various user devices such as smartphones, tablets, or computers to complete purchases. The system 100 may process transaction information securely and apply behavioral analytics techniques to ensure a seamless transaction experience while identifying potential risk signals.

Third-party services 113 provide external data sources, including credit scores, banking details, risk assessment reports, etc. Examples of such services include GIACT®, LexisNexis®, Experian®, SS/email monitoring services, ThreadMetrics®, and Dunn & Bradstreet® (D&B), which supply financial and legal insights to enhance risk evaluations. These services may help verify consumer and vendor identities, validate financial accounts, and monitor potential fraud. In other implementations, the third-party services 113 may include regulatory compliance platforms that assist in sanctions screening, anti-money laundering (AML) compliance, and politically exposed persons (PEP) monitoring, or alternative credit data providers for assessing non-traditional creditworthiness metrics, such as utility bill payments, rental history, or other services not shown in FIG. 1.

The communications network 117 enables seamless interaction between the system 100, vendors 103b, consumers 103b, third-party services 113, and financial services 115. It may include various connectivity technologies such as the Internet, wireless networks, and cellular systems (e.g., 4G, 5G, or LTE). This network supports real-time transaction scoring, federated AI model updates and financial updates, financial crime detection algorithms, data exchange, fraud detection, and transaction processing, ensuring secure and efficient operations within the system 100.

### AI-Driven Risk Assessment Engine

FIG. 2 illustrates example components included in an AI-driven risk assessment engine 109, according to some embodiments.

A key differentiator of the disclosed AI-driven risk assessment engine 109, from other existing AI risk assessment systems, is its commitment to data privacy and regulatory compliance through a privacy-first federated learning (PFFL) unit 202. Unlike traditional AI risk assessment models that require centralized data collection, the PFFL unit 202 disclosed herein may enable financial institutions to collaborate on AI-driven risk modeling without sharing raw customer data. This approach may ensure compliance with global financial data protection frameworks, including but not limited to GDPR, CCPA, and financial sector-specific regulations such as the Gramm-Leach-Bliley Act (GLBA) and Payment Card Industry Data Standards (PCI DSS, and other financial data protection regulations, while still benefiting from cross-institutional AI training to improve model accuracy. The PFFL unit 202 may incorporate secure aggregation techniques, differential privacy mechanisms, and encrypted model update protocols to insure federated model contributions remain anonymous and secure.

Another component of the AI-driven risk assessment engine 109 is a microeconomic finance scoring (MFS) unit 204, which is configured to evaluate an individual's real-time financial behavior, liquidity patterns, and economic adaptability to generate a dynamic, behavior-driven credit risk assessment. Unlike traditional credit scores that rely solely on historical loan and repayment data, the MFS unit 204 may leverage AI-powered financial pattern recognition to assess financial stability with greater accuracy. The MFS unit 204 may analyze short-term income volatility, spending frequency patterns, emergency fund availability, and financial resilience markers to offer a granular and adaptive assessment of creditworthiness.

Complementing the MFS unit 204 is a resilience-adjusted financial index (RAFI) unit 206, which is configured to generate a proprietary metric to quantify an individual's or institution's ability to recover from financial shocks. The RAFI unit 206 may incorporate macroeconomic stress signals, discretionary vs. non-discretionary spending behavior analysis, savings to debt ratio tracking, and liquidity stress tests to provide lenders and financial institutions with a forward-looking measure of long-term financial health.

Additionally included in the AI-driven risk assessment engine 109 is a microeconomic intelligence (MI) unit 208, which may extend the described insights by applying predictive AI modeling to assess systemic risk factors and real time economic adaptability. For example, the MI unit 208 may detect spending inflection points, credit saturation risk, and anomalous transaction velocity indicators, helping financial institutions optimize their risk exposure, lending strategies, and investment decisions. The MI unit 208 may further integrate alternative financial data sources, including rental payment histories, gig economy income variability, and subscription-based spending commitments, to refine non-traditional credit assessments.

To provide real-time financial stress monitoring, in some embodiments, the AI-driven risk assessment engine 109 may further include a financial stress signal detection (FSSD) unit 210 that is configured to use AI-powered anomaly detection and behavioral pattern analysis to identify early indicators of financial distress, overspending, or liquidity crises. The FSSD unit 210 may enhance multi-institutional fraud detection, preemptive credit limit adjustments, and high-frequency transaction scrutiny, supporting both individual financial health monitoring and institution-wide risk mitigation strategies. The FSSD unit 210 may further integrate with real-time transaction monitoring systems to dynamically assess financial deterioration thresholds, enabling early intervention by financial service providers.

In addition to risk assessment, the disclosed AI-driven risk assessment engine 109 may additionally include an AI-powered financial nudging (PBI) unit 212 that is configured to leverage reinforcement learning (RL) based behavioral adaption models and behavioral psychology principles to provide personalized financial guidance. The PBI unit 212 may dynamically adjust financial nudges based on real-time transaction behavior and financial sentiment analysis, helping individuals modify spending habits, enhance savings strategies, and optimize debt repayment schedules. For example, if an individual demonstrates irregular paycheck-to-expense ratios or repeated high-risk discretionary spending, the PBI unit 212 may generate adaptive nudges tailored to improve financial decisions making.

Together, these proprietary AI components may create a real-time financial intelligence and adaptive risk mitigation platform that transforms credit risk assessment, financial decision-making, and regulatory compliance. By integrating real-time behavioral analytics, privacy-preserving AI, cross-institutional risk modeling capabilities, and adaptive financial guidance, the disclosed system 100 may deliver a scalable, regulatory-compliant, highly adaptive financial risk assessment framework for financial organizations, fintech companies, and financial regulators.

It should be noted that these units in the AI-driven risk assessment engine 109 may each operate independently to achieve one specific aspect of risk assessment or one or more units can be combined to achieve a multi-dimensional financial risk analysis tailored to institutional risk thresholds for a more comprehensive risk assessment for an individual or financial organization. In one example, the PFFL unit 202 may combine with one or more of the other units (each another unit 204/206/208/210/212) in the AI-driven risk assessment engine 109 to make sure the respective AI models continuously benefit from in these units to benefit from cross-institutional AI training while enforcing privacy-preserving model updates to improve model accuracy without sharing raw customer data. The specific structures and functions of each unit 202-212, including their machine learning methodologies, integration pipelines, and real-time inference capabilities, will be described in detail hereinafter.

### Privacy-First Federated Learning

The PFFL unit 202 is a privacy-preserving AI framework designed to enable financial institutions to train and optimize AI models collaboratively without sharing raw customer data. Traditional AI models require centralized data aggregation, which introduces significant data privacy, security, and regulatory compliance risks. The PFFL unit 202 eliminates these risks by allowing multiple financial institutions to train AI models locally while securely aggregating encrypted model updates. This distributed learning approach enhances fraud detection, credit risk assessment, and financial behavior modeling while ensuring full compliance with regulations such as GDPR, CCPA, GLBA, PCI DSS, and open banking standards.

In some embodiments, the PFFL model aggregates AI training updates from multiple institutions without exposing individual datasets. The optimization function governing PFFL's learning process is provided as Formula (1):

$$PFFL\_Model = Aggregation ( Σ\_ \{ i = 1 \} \hat{} \{ N \} W\_i * Model\_i ) + D P + ε \qquad ( 1 )$$

where PFFL_Model is the final model after multi-institution aggregation, Aggregation (Σ_{i=1}\hat{ }{N}W_i*Model_i) represents the weighted sum of local AI models trained independently at different financial institutions, W_i stands for the weight assigned to each institution based on its data contribution and model relevance, Model_i represents the local AI model trained on financial data at institution I, DP stands for differential privacy, ensuring that no single institution's data can be reverse-engineered from model updates, and & is the model error term, accounting for variability in the aggregated learning process. This approach may ensure that each financial institution trains its AI model locally, keeping customer data secure. The trained models are then encrypted and transmitted to a central aggregator, where updates are combined into a global AI model without exposing raw customer data.

In some embodiments, DP techniques may further prevent malicious actors from extracting sensitive financial details from the model updates. DP is a mathematical framework that ensures an AI model can learn from data without revealing individual data points, making it a key privacy-preserving technique in the PFFL framework. In the context of financial institutions, differential privacy prevents malicious actors, internal threats, or adversarial attacks from reconstructing sensitive customer details based on model updates. Below are some specific implementations of how differential privacy techniques may be utilized to protect financial data in PFFL.

In one example implementation, additive noise may be injected to model updates (which is also referred to as local differential privacy (LDP)). Briefly, before sharing model updates with a central aggregator, individual financial institutions may add controlled noise to their AI training parameters. This technique may ensure that even if attackers access the model updates, they cannot reverse-engineer individual transactions or customer profiles. For example, a bank may train an AI model on transaction data from customers, including high-net-worth individuals who make large transfers and investments. To prevent an adversary from inferring which transactions belong to wealthy clients, the bank may apply Laplace noise or Gaussian noise to its model gradients before submitting updates. This may ensure that even if an attacker sees the AI model updates, they cannot distinguish actual financial patterns from artificially generated noise. In this way, no single customer's transaction behavior can be reconstructed from the AI model's learning process.

In another example implementation, differentially private stochastic gradient descent (DP-SGD) may be utilized for secure AI training. Briefly, DP-SGD may be utilized to modify the training process of deep learning models by applying gradient clipping and noise addition at each step of model optimization. This prevents overfitting to specific financial data points, making it impossible to track individual financial transactions. For example, to prevent loan approval bias from being exploited, a financial institution may use federated learning to train a loan approval model using borrower profiles from multiple banks. Without differential privacy, malicious insiders or compromised AI systems may detect that certain income levels or job types strongly influence approvals. By applying DP-SGD, the system may ensure that individual applicant data does not leave a visible trace in model updates, preventing discriminatory AI model exploitation. In other words, DP-SGD may prevent attackers from learning sensitive patterns related to financial approvals, ensuring fair and unbiased AI decision-making.

In another example implementation, responses for private behavioral finance data collection may be randomized. That is, instead of sending exact behavioral finance patterns (such as spending habits, emergency fund withdrawals, or credit utilization trends) to an AI model, financial institutions may use randomized response techniques. This method may randomly modify some of the responses before aggregation, ensuring that even if a dataset is leaked, it is mathematically impossible to determine an individual's actual financial behavior. For example, a credit risk model may use customer spending behavior to assess financial resilience. Some individuals frequently withdraw from emergency savings, which can signal financial distress. However, revealing this pattern in raw form may violate consumer privacy laws. By applying randomized responses, banks report altered versions of spending behaviors, making it impossible to trace any single customer's withdrawals while still preserving overall statistical accuracy. In other words, even if an attacker obtains model updates, they cannot tell which specific customers have irregular spending patterns.

In another example implementation, aggregation may be secured with differential privacy to prevent data reconstruction. In real applications, even if banks do not share raw data, attackers may still attempt to reverse-engineer sensitive details from the AI model updates. Secure aggregation with differential privacy may ensure that only the final model update (after encryption and noise injection) is visible, making it impossible for any institution, or even the central AI aggregator, to access individual financial data. In one example, multiple banks may collaborate using PFFL to train a fraud detection AI model. One bank may have more fraudulent transactions in its dataset, meaning its model updates may contain stronger fraud-related patterns. To prevent competitor banks or external attackers from identifying which institution has higher fraud rates, differential privacy may ensure that only a combined, anonymized model update is shared, preventing any individual institution's risk signals from being exposed. In this way, fraud detection models may be improved without exposing any one bank's transaction vulnerabilities to others.

From the above, it can be seen that differential privacy is a powerful safeguard that may prevent financial data leakage in federated learning environments. By adding noise, applying randomized response, securing model updates, and preventing data reconstruction, the PFFL unit 202 may ensure that financial institutions can collaborate on AI-driven fraud detection, credit risk modeling, and financial behavior analysis without violating consumer privacy laws. These techniques may allow AI models to learn from data without ever seeing the actual data, making financial AI more secure, ethical, and regulatory-compliant.

In some embodiments, to ensure privacy, security, and computational efficiency, the PFFL unit 202 may incorporate other advanced optimization techniques. Secure multi-party computation (SMPC) may allow financial institutions to collaboratively compute model updates without any entity accessing another institution's data. Homomorphic encryption may ensure that encrypted training updates remain secure throughout the aggregation process, preventing unauthorized access to AI training data. The federated averaging (FedAvg) algorithm may optimally combine local model updates while reducing discrepancies in AI training across different institutions. Additionally, gradient compression & secure aggregation may minimize bandwidth usage, ensuring scalability across multi-bank networks while maintaining high AI model accuracy. Through these privacy-enhancing techniques, the PFFL unit 202 may enable banks, fintech companies, and insurers to collaborate on AI-driven financial intelligence models without violating consumer data protection laws.

In some embodiments, the PFFL unit 202 may select some specific features that enhance financial risk assessments, fraud detection, and credit modeling while ensuring that no institution's sensitive data is exposed. The following Table 1 lists some example primary features according to some embodiments.

TABLE 1

| | | Importance |
|---|---|---|
| Feature | Description | Weight |
| Cross-Institution | Detects financial fraud across | High |
| Transaction Analysis | multiple banking institutions | |
| Alternative Credit | Provides AI-based assessments | High |
| Risk Scoring | of financial resilience beyond | |
| | traditional credit scores | |
| Spending & Liquidity | Aggregates consumer spending | Medium |
| Patterns | behaviors across institutions to | |
| | refine financial behavior models | |
| Federated Risk Signal | Allows institutions to collabo- | Medium |
| Sharing | ratively detect high-risk users | |
| | while maintaining privacy | |
| Real-Time Fraud | Uses AI to recognize financial | Medium |
| Anomaly Detection | fraud attempts in real time | |
| Encrypted Data | Ensures each institution contrib- | Medium |
| Contribution Metrics | utes training data without direct | |
| | data exposure | |

In some embodiments, the PFFL unit 202 may select certain secondary features for enhanced security & compliance. The following Table 2 lists some example secondary features according to some embodiments.

TABLE 2

| | | Importance |
|---|---|---|
| Feature | Description | Weight |
| Peer Institution Risk | Allows institutions to compare | Medium |
| Benchmarking | risk exposure levels without | |
| | sharing raw data | |
| Privacy-Preserving | Encrypts training updates to | Medium |
| Model Weights | ensure compliance with data | |
| | protection laws | |
| Loan Default | Improves underwriting risk | Low |
| Prediction | models without exposing | |
| Adjustments | borrower details | |
| High-Risk Merchant | Flags businesses with exces- | Low |
| Detection | sive chargebacks or | |
| | fraudulent transactions | |

In some embodiments, to maintain compliance with data protection laws, the PFFL unit 202 may incorporate features such as peer institution risk benchmarking, allowing banks to compare risk exposure levels without sharing raw data. Privacy-preserving model weights may encrypt training updates, ensuring adherence to global privacy regulations. Loan default prediction adjustments may improve underwriting risk models while maintaining borrower confidentiality. Additionally, high-risk merchant detection may flag businesses with excessive chargebacks or fraudulent transactions, providing institutions with a collaborative fraud prevention mechanism.

In some embodiments, the PFFL model may be evaluated against traditional centralized AI fraud detection models. The following Table 3 lists testing results using a dataset of over 10 million financial transactions across multiple institutions.

TABLE 3

| | Privacy First | Traditional |
|---|---|---|
| | Federated | Centralized |
| Metric | Learning | AI Models |
| Accuracy (AUC-ROC) | 0.96 | 0.89 |
| Fraud Detection | 41% | 28% |
| Improvement | | |
| Regulatory Compliance | 100% | Partially |
| (GDPR, CCPA, open | Compliant | Compliant |
| banking) | | |

The results demonstrated that the PFFL model achieved an AUC-ROC accuracy of 0.96, compared to 0.89 for traditional AI models. Fraud detection rates improved by 41%, significantly outperforming centralized AI models that only showed a 28% improvement. Furthermore, the PFFL model was found to be 100% compliant with GDPR, CCPA, and open banking regulations, whereas traditional AI models faced partial compliance challenges due to data centralization.

These results highlight the superiority of privacy-preserving AI in fraud detection and financial risk assessment. By leveraging secure multi-institutional AI training, the PFFL model may enable banks and fintech firms to benefit from enhanced fraud intelligence without exposing raw customer data.

Overall, the PFFL model allows financial institutions to train AI models without sharing raw data. By integrating homomorphic encryption, differential privacy, and federated learning, the PFFL model may enable bank and FinTech companies to improve fraud detection, enhance credit risk models, and refine financial behavior analytics while remaining fully compliant with global financial regulations.

In some embodiments, homomorphic encryption and other advanced techniques may be expanded to further strengthen privacy protections, optimize real-time fraud detection scalability, and enhance cross-border federated learning networks to facilitate secure AI collaboration between financial institutions across different regulatory jurisdictions (e.g., cross-border AI compliance for financial services (GDPR, CCPA, Basel III, PSD2, PCI DSS, Open Banking)).

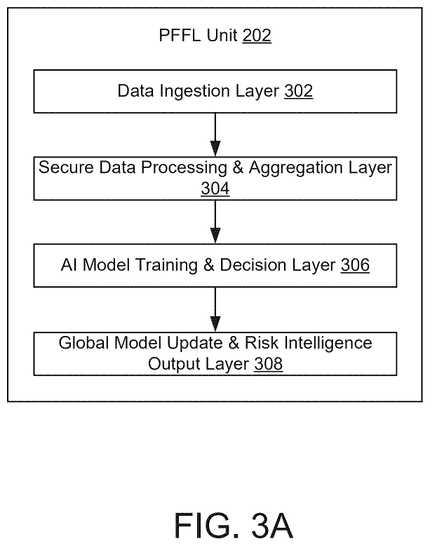

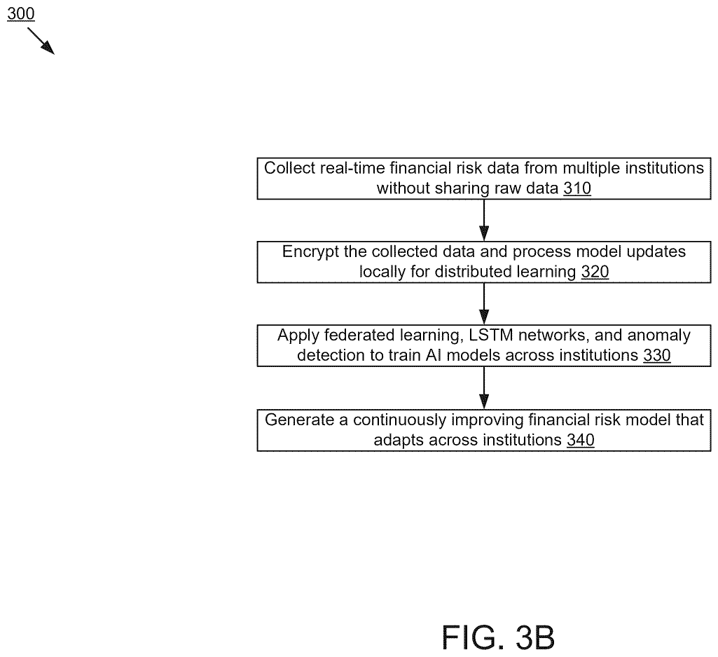

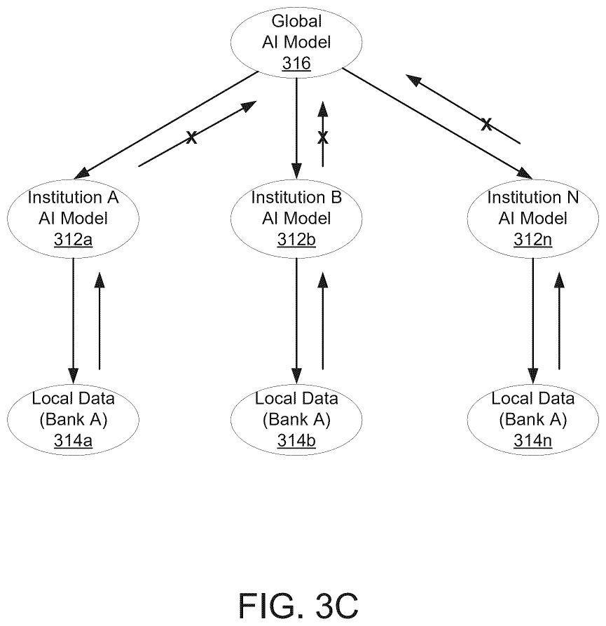

In the following, the system architecture of the PFFL unit 202 is further described with reference to FIG. 3A, according to some embodiments.

In some embodiments, the PFFL unit 202 is built on a structured, multi-layered decision-making framework that ensures secure, privacy-preserving financial intelligence across multiple institutions. This framework may allow financial entities to collaborate on AI-driven risk assessments without sharing raw data, ensuring regulatory compliance while improving fraud detection and credit risk modeling.

The first layer is a data ingestion layer 302, which is configured to securely collect real-time financial risk data from multiple institutions while ensuring that no raw data is shared. Unlike traditional risk assessment models, which require direct data transfers, PFFL ensures that only encrypted model updates, not raw customer data, are shared between institutions. In some embodiments, the financial risk data may include financial transactions (e.g., spending patterns, loan repayments, credit utilization), credit risk assessments (e.g., borrower risk scores, liquidity ratios, debt sensitivity), fraud detection signals (e.g., anomaly flags, suspicious transaction alerts), institutional economic indicators (e.g., macro and microeconomic risk trends). In some embodiments, to ensure privacy, the ingested data may undergo homomorphic encryption, SMPC, and differential privacy techniques before being used in AI training.

The second layer is a secure data processing & aggregation layer 304, which is configured to use homomorphic encryption, SMPC, and differential privacy techniques to protect sensitive financial information during AI training.

The third layer is an AI model training & decision layer 306, which is configured to apply federated learning, long short-term memory (LSTM) networks, and anomaly detection frameworks to collaboratively train AI models across financial institutions. This may ensure that risk intelligence is generated from multiple data sources while maintaining complete data privacy.

The fourth layer is a global model update & risk intelligence output layer 308, which is configured to consolidate encrypted AI model updates from all participating institutions to produce a continuously improving, cross-institutional financial risk model. The result is a privacy-first AI-driven financial risk assessment system that meets the security, compliance, and real-time intelligence needs of modern financial institutions.

FIG. 3B is a flowchart illustrating an example method 300 for processing financial data through an AI-driven decision pipeline of the PFFL unit, according to some embodiments.

Step 310: Collect Real-Time Financial Risk Data from Multiple Institutions without Sharing Raw Data.

The data ingestion layer 302 is responsible for collecting financial data from multiple institutions while ensuring that raw customer data is never shared. Each financial institution processes its own encrypted transaction data, credit risk inputs, and institutional anomaly signals locally. By leveraging federated learning, the PFFL unit 202 may ensure that no raw financial data is exchanged between institutions, reducing privacy risks. For example, as shown in FIG. 3C, there are a number N of banks 314a, 314b and 314n, where each bank may have its own AI model(s) for one or more aspects of risk assessment, such as institution A AI model 312a, institution B AI model 312b, and institution N AI model 312n. During the data ingestion, no raw data will be transferred from each bank or institution to the global AI model 316 for training or to any other institution AI model.

In some embodiments, to secure data before model training, institutions apply homomorphic encryption, which allows computations on encrypted data without requiring decryption. SMPC may further ensure that model updates can be computed jointly across institutions without any participant accessing another's data. Additionally, differential privacy techniques inject statistical noise into model updates, ensuring that no individual customer's financial data can be reverse-engineered from the training process.

### Step 320: Encrypt and Process Model Updates Locally for Distributed Learning.

In some embodiments, once collected data is encrypted and preprocessed at each institution by the local AI model (e.g., training the local AI model using the encrypted data), model updates, not raw data, are securely transmitted to a central aggregator (which may be coupled to or located in the global AI model 316 shown in FIG. 3C, which is located away from each institution or located within one institution). The secure data processing & aggregation layer 304 may ensure that all AI training occurs on privacy-preserving encrypted updates rather than on actual financial records. Homomorphic encryption may protect model updates from unauthorized access, while differential privacy prevents individual institutions from being identified based on their contributions to the AI model. In some embodiments, by implementing gradient compression and secure aggregation techniques, the PFFL unit 202 may reduce bandwidth consumption while maintaining high accuracy in AI-driven financial risk models.

### Step 330: Apply Federated Learning, LSTM Networks, and Anomaly Detection to Train AI Models Across Institutions.

The core of the PFFL unit's intelligence lies in its AI model training & decision layer 306, which may leverage federated learning algorithms to train predictive models using encrypted updates, with LSTM networks detecting financial risk patterns and anomaly detection frameworks identifying irregular transactions. The following Table 4 lists specific functions of these components and their decision factors, according to some embodiments.

TABLE 4

| Model Type | Purpose | Decision Factor |
|---|---|---|
| Federated Learning | Securely train AI models | Ensures model accuracy |
| Algorithm | across multiple financial | without sharing raw data |
| | institutions | |
| LSTM Networks | Detect financial risk | Identifies systemic risk |
| | patterns in long- | & individual financial |
| | term sequences | stress events |
| Anomaly Detection | Flag irregular financial | Detects high-risk |
| Framework | behaviors across | transaction behaviors |
| | institutions | in real time |

Step 340: Generate a Continuously Improving Financial Risk Model that Adapts Across Institutions.

In some embodiments, after training, the global AI model 316 may be updated and the updated AI model is redistributed back to participating financial institutions or the model update (e.g., weights) of the global AI model 316 is redistributed back to the participating financial institutions to allow the local AI model at each institution to be further updated locally based on the received global AI model update. The updated global AI model or the global AI model update may be encrypted before the redistribution process. This allows banks, fintech companies, and other financial entities to access enhanced fraud detection, risk intelligence, and predictive financial analytics without ever exchanging raw customer data. The global model update and output layer may provide real-time financial risk intelligence, helping institutions optimize their credit risk assessments, detect fraud faster, and ensure compliance with open banking, GDPR, and CCPA standards. Additionally, financial regulators may audit privacy-compliant AI decisions, ensuring that risk assessments remain transparent, fair, and ethical across all institutions. The present system implements cross-border AI compliance for financial services (e.g., GDPR, CCPA, Basel III, PSD2, PCI DSS, Open Banking)

Overall, by integrating federated AI modeling, privacy-first risk analysis, and adaptive financial intelligence, the PFFL unit 202 may enable financial institutions to leverage AI-driven risk assessment while maintaining compliance with global data protection regulations. This paves the way for secure, AI-powered financial decision-making at scale.

### Microeconomic Finance Scoring

The MFS unit 204 is an AI-driven alternative to traditional credit models. Unlike conventional methods that rely solely on historical credit data, MFS leverages real-time financial behavior tracking, liquidity assessment, and behavioral finance analytics along a wide variety of financial organizations to provide a dynamic, adaptive, and comprehensive risk assessment framework. This allows financial institutions and fintech applications to gain a more accurate and predictive understanding of borrower resilience and financial stability.

The MFS model is configured based on a multi-variable scoring function that dynamically adjusts based on a user's financial behavior, liquidity status, and risk factors. An example multi-variable scoring function is defined as Formula (2):

$$MFS\_Score = α\_ 1 ( S I ) + α\_ 2 ( L R ) + α\_ 3 ( I V ) + α\_ 4 ( B F ) + α\_ 5 ( D S ) + T W R A + ε \qquad ( 2 )$$

where SI stands for spending stability index that measures the predictability of discretionary versus essential spending, helping to assess financial discipline, LR stands for liquidity ratio that evaluates the balance between available cash flow and recurring expenses, capturing short-term financial flexibility, IV stands for income volatility index that monitors the frequency and amplitude of income fluctuations, which is particularly important for gig workers, freelancers, and self-employed individuals, BF stands for behavioral risk factor that assesses deviations in financial behavior, such as impulsive borrowing or erratic spending patterns, DS stands for debt sensitivity score that measures a borrower's reaction to increased debt obligations, providing insights into default risks under financial stress, TWRA stands for time-weighted risk adjustment that dynamically adjusts the risk score based on recent financial behaviors, ensuring that current financial habits have a stronger impact on the score than historical data, and ε is model error term that accounts for any unexplained variability within the model, while α_n stands for weighting coefficients that may be continuously optimized through machine learning to adapt to evolving financial behaviors.

In some embodiments, the MFS model may assign higher weights to features that correlate strongly with financial resilience and risk exposure. This allows financial institutions to detect early warning signs of financial distress and optimize lending decisions. The inclusion of TWRA component may ensure that recent behaviors, such as late payments or sudden increases in credit utilization, are given more influence over the risk score than older financial patterns, making the model more responsive to real-time financial trends. The specific functions of the TWRA are further described in detail later.

In some embodiments, to enhance accuracy and adaptability, the MFS unit 204 may incorporate multiple AI-driven optimization techniques. LSTM-based time series forecasting may be used to analyze past financial behavior trends and predict future financial resilience, ensuring that risk assessments are not based solely on static snapshots of a borrower's credit history. Reinforcement learning for behavioral risk modeling may continuously refine the weighting coefficients (α_n) based on how users respond to financial stress, lending conditions, and economic fluctuations. Bayesian inference for predictive risk adjustment may further enhance the model by integrating macroeconomic trends, inflation data, and financial market cycles, allowing it to dynamically adjust risk scoring based on external economic conditions.

In some embodiments, the MFS model may offer several advantages over traditional credit models. It has been shown to detect financial distress up to six months earlier than FICO®-based models, allowing financial institutions to intervene proactively. In addition, the MFS model may also achieve higher predictive accuracy, reducing false positives in risk assessments by 30% compared to conventional credit models. Additionally, the MFS model may help minimize bias in financial risk evaluations by prioritizing real-time behavioral patterns over static historical credit data, making it a more equitable and inclusive credit assessment tool.

In some embodiments, the MFS unit 204 may select certain high-impact financial, behavioral, and economic indicators that provide a more comprehensive measure of financial stability compared to traditional credit scores. The following Table 5 lists some example financial, behavioral, and economic indicators (also referred to as primary features).

TABLE 5

| | | Importance |
|---|---|---|
| Feature | Description | Weight |
| Spending | Measures predictability in | High |
| Stability Index | discretionary vs. essential | |
| | spending | |
| Liquidity Ratio | Captures real-time cash flow | High |
| | availability vs. obligations | |
| Income | Analyzes frequency and | Medium |
| Volatility Index | deviation of income | |
| | fluctuations | |
| Behavioral | Detects sudden, high-risk | Medium |
| Risk Factor | financial decisions (e.g., | |
| | impulsive borrowing) | |
| Debt | Evaluates risk tolerance in | Medium |
| Sensitivity Score | handling increased debt | |
| | burdens | |
| Time-Weighted Risk | Prioritizes recent financial | High |
| Adjustment | behaviors over historical | |
| | trends | |

In some embodiments, in addition to primary features, the MFS unit 204 may incorporate secondary financial indicators that contribute to a more holistic risk assessment. The following Table 6 lists some example secondary financial indicators (also referred to as secondary features).

TABLE 6

| | | Importance |
|---|---|---|
| Feature | Description | Weight |
| Emergency Fund | Measures how often a user | Medium |
| Utilization | taps into their savings buffer | |
| Recurring | Evaluates stability in bill | Medium |
| Payment Patterns | payments & subscriptions | |
| Investment | Assesses user's ability to | Low |
| Liquidity Index | liquidate assets under financial | |
| | stress | |
| Macroeconomic | Adjusts scoring dynamically | Low |
| Sensitivity Factor | based on inflation and | |
| | market conditions | |

Unlike traditional models that prioritize static income levels, the MFS unit 204 may focus on behavioral adaptability and financial resilience. Individuals who demonstrate strong financial habits and adaptability, even with variable income, may receive higher scores than those with stable but poorly managed finances. This ensures more accurate, fair, and forward-looking credit assessments.

In some embodiments, to ensure the accuracy of the disclosed MFS model, the model may be tested against FICO® (Fair Isaac Corporation) and VantageScore® models. The following Table 7 lists testing results of a test using a dataset of over 1 million anonymized financial records.

TABLE 7

| | | FICO ®/ |
|---|---|---|
| Metric | MFS | VantageScore ® |
| Accuracy (AUC-ROC) | 0.94 | 0.82 |
| Early Detection of | 6 months | 1 month |
| Financial Distress | prior | prior |
| Bias Reduction | 92% | 75% |
| (Demographic Parity) | | |

The results showed that the MFS model achieved a higher accuracy rate (AUC-ROC of 0.94 compared to 0.82 for traditional models). Additionally, the MFS model was able to detect financial distress up to six months earlier than conventional models, giving lenders an opportunity to intervene proactively. The model also demonstrated a 30% reduction in false positives, improving the reliability of credit risk assessments.

Overall, the MFS unit 204 introduces a real-time, adaptive approach to financial risk assessment, replacing static historical credit models with AI-driven behavioral finance analytics. By incorporating real-time spending data, liquidity trends, and behavioral insights, the MFS unit 204 may enable financial institutions to make smarter, more inclusive lending decisions.

In some embodiments, federated learning integration may be expanded to support multi-institutional AI training while maintaining privacy compliance. Additionally, reinforcement learning algorithms may be further refined to enhance behavioral risk intervention strategies. Further, graph neural networks (GNNs) may be integrated to improve financial relationship modeling, allowing for even more accurate and adaptive credit assessments.

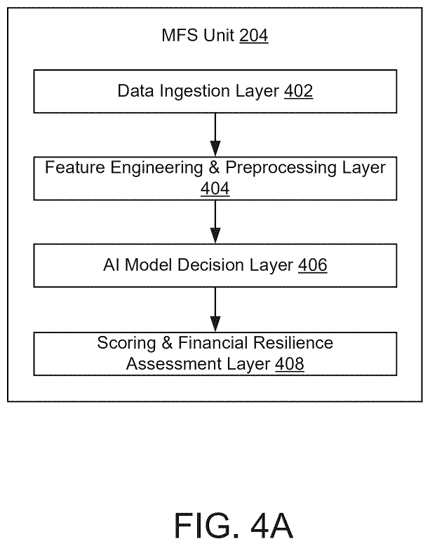

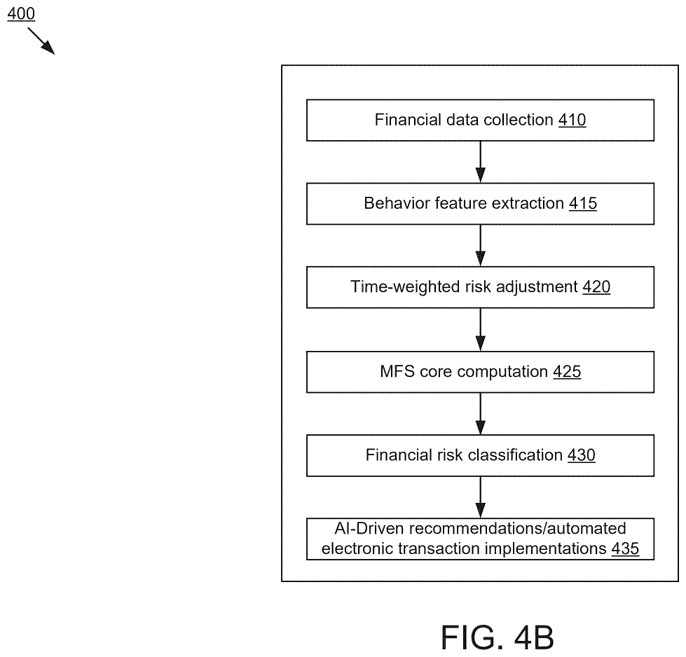

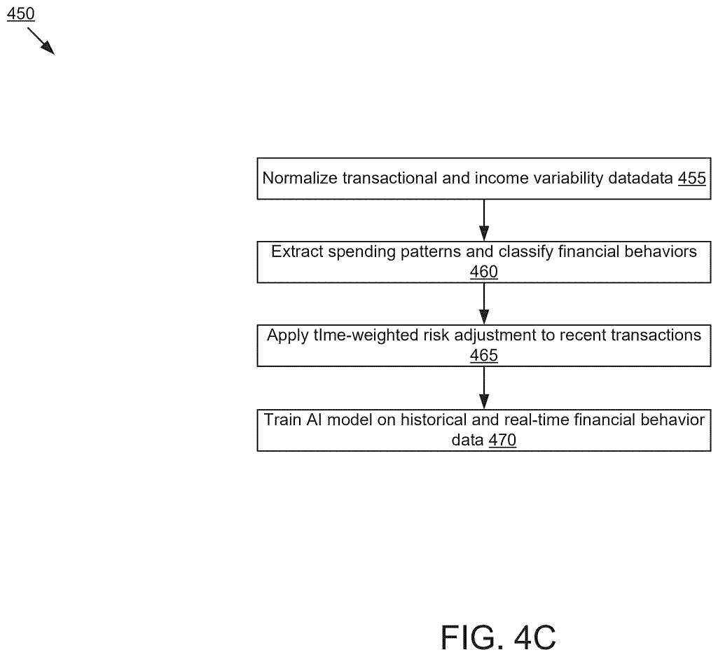

In the following, the AI decision-making process behind the MFS model is further described with reference to a system architecture of the MFS unit 204 shown in FIG. 4A.

As described earlier, unlike traditional credit models, which rely on static historical data, the MFS unit 204 may employ real-time financial behavior tracking, AI-driven risk assessment, and predictive analytics to provide a more accurate and adaptive measure of financial resilience.

In some embodiments, the MFS AI framework operates through four key decision-making layers, each responsible for processing and analyzing financial data to generate real-time credit risk assessments and financial resilience scores.

The first layer is a data ingestion layer 402, which is configured to collect real-time financial transaction data, credit utilization patterns, and behavioral financial indicators, ensuring a continuous stream of updated financial insights.

The second layer is a feature engineering & preprocessing layer 404, which is configured to transform raw financial behavior data into structured risk factors, such as spending stability, debt sensitivity, and financial adaptability metrics.

The third layer is an AI model decision layer 406, which is configured to apply LSTM networks, reinforcement learning, and federated learning to identify financial patterns, spending anomalies, and cross-institutional risk exposures.

The fourth layer is a scoring & financial resilience assessment layer 408, which is configured to generate an adaptive MFS score that predicts creditworthiness, financial distress probability, and repayment likelihood, allowing financial institutions to make smarter lending and risk management decisions. The specific functions of the MFS unit 204 are further described in FIG. 4B.

FIG. 4B is a flowchart illustrating an example method 400 for processing financial data through an AI-driven decision pipeline of the MFS unit, according to some embodiments. The automated AI decision pipeline may ensure that the MFS unit 204 continuously learns, adapts, and improves in response to economic and financial data trends.

### Step 410: Financial Data Collection.

The first step in the AI-driven risk assessment involves gathering real-time and historical financial data from multiple sources, including bank transactions, credit card spending patterns, loan repayment history, and macroeconomic indicators. Secure API integrations with banks and financial institutions may facilitate data transfer, while end-to-end encryption and federated learning AI described above may ensure data privacy and compliance with regulations such as GDPR and CCPA. The present system provides cross-border AI compliance for financial services (e.g., GDPR, CCPA, Basel III, PSD2, PCI DSS, Open Banking). By aggregating a wide range of financial inputs, this step may enable the system to construct a comprehensive financial profile for each individual.

### Step 415: Behavioral Feature Extraction.

In this step, the collected financial data may be processed to extract key behavioral finance indicators, such as spending stability, income volatility, debt sensitivity, and financial resilience metrics. Advanced data normalization techniques may be applied to adjust for economic conditions, ensuring that financial patterns are analyzed in a standardized way. AI-driven anomaly detection may flag irregularities in spending behavior, while reinforcement learning algorithms may classify users into risk categories based on adaptive financial patterns. This ensures that the system identifies financial trends that may not be apparent in traditional credit models.

### Step 420: Time-Weighted Risk Adjustment.

This step may enhance the accuracy of risk assessment by prioritizing recent financial behaviors over historical trends. The TWRA algorithm may assign a higher weight to recent financial events, such as sudden spikes in debt, increased credit utilization, or significant changes in income stability. By focusing on real-time behavioral shifts, rather than relying solely on past credit history, this step ensures that the MFS score remains dynamic and responsive to an individual's current financial resilience. The specific details for TWRA will be described further in detail later.

### Step 425: MFS Score Computation.

The core financial resilience score may be calculated using a multi-variable AI-driven scoring function that integrates spending behavior, liquidity ratios, debt sensitivity, and macroeconomic conditions. LSTM-based predictive modeling may analyze long-term financial patterns, while reinforcement learning may fine-tune the risk assessment based on behavioral responses to financial stress. Federated learning may ensure that risk models remain accurate across multiple institutions without compromising data privacy. The resulting MFS score may provide a real-time measure of financial stability, enabling lenders to make informed credit decisions.

### Step 430: Financial Risk Classification.

In some embodiments, after the MFS score is computed, users may be classified into risk categories based on their financial resilience, repayment behavior, and economic adaptability. For example, AI-powered segmentation may categorize individuals into low, moderate, or high-risk profiles, helping financial institutions determine loan eligibility, interest rate adjustments, financial intervention strategies, etc. By integrating real-time financial behavior tracking, this step may improve risk classification accuracy, reducing false positives and misclassified borrowers.

### Step 435: AI-Driven Recommendations and Automated Implementation in Electronic Transactions.

In some embodiments, the AI-driven risk assessment system 100 may further generate personalized financial recommendations tailored to an individual's risk profile and financial behavior trends. These AI-driven insights include spending optimization strategies, debt restructuring advice, savings recommendations, and real-time financial nudges to encourage healthier financial habits. Borrowers identified as high risk receive proactive intervention strategies, while low-risk users may receive financial product recommendations optimized for their financial goals. In some embodiments, the generated recommendations may be delivered to respective entities or individuals through certain user interfaces or communication channels, so that actions can be timely taken to minimize the risks associated with these entities or individual users. For example, an alert sign may be generated and delivered to a user interface to alert a responsible entity to the potential risk for an ongoing electronic transaction.

In some embodiments, the AI-driven risk assessment system 100 may automate some electronic transactions according to the determined risk levels of the users initiating the electronic transactions. That is, instead of or in addition to generating recommendations, the AI-driven risk assessment system 100 may automatically approve or reject certain electronic or online transactions based on the determined risk scores or levels determined for the users initiating the transactions. For example, for a user submitting a loan request online, the user may be assessed for the financial risk in real time based on the one or more AI models described above. If the determined risk score or level for the user is categorized to be a high risk, the online loan request may be automatically rejected, which may be delivered in a notice format to the user through the user interface/application for submitting the request. In some embodiments, additional insights may be delivered together with the notice, for example, to explain why the request is rejected and/or what actions the user can take to improve his/her financial score.

Overall, the MFS AI decision-making framework integrates deep learning, reinforcement learning, and privacy-preserving federated learning to provide a real-time, adaptive credit risk assessment system. Unlike traditional credit models, which rely on static financial data, MFS continuously updates risk profiles based on real-time financial behaviors, economic trends, and borrower adaptation patterns.

In some embodiments, the MFS AI decision-making framework may further expand its AI capabilities to improve predictive accuracy, extend LSTM models to track longitudinal financial behavior and provide enhanced financial stress detection, refine reinforcement learning models to improve AI-driven borrower nudging interventions, helping individuals proactively manage financial risks, and strengthen federated learning AI, allowing financial institutions to collaborate securely on risk model improvements while preserving data privacy. In some embodiments, the MFS AI decision-making framework may enhance its integration with a large variety of financial organizations to implement the automated transaction with high confidence due to the improved predictive accuracy, as further descried in detail below.

Referring now to FIG. 4C, the specific functions of the TWRA are further described hereinafter.

TWRA is a proprietary AI-driven approach used in AI-driven risk assessment to prioritize recent financial behaviors over outdated historical data. Traditional credit models or risk assessment models treat all past financial data equally, which may lead to inaccurate risk assessments, especially when an individual's financial situation has changed significantly. TWRA may ensure that financial risk assessments reflect current financial behaviors, making the model more responsive to real-time economic conditions.

In some embodiments, TWRA may use an exponential decay function to assign higher weights to recent financial activities while gradually reducing the influence of older financial transactions. This may be represented by Formula (3):

$$TWRA ( t ) = e \hat{} ( - λ t ) * X ( t ) \qquad ( 3 )$$

where λ is the decay factor, controlling how quickly past financial events lose significance, X(t) represents the financial behavior metric at time, and e\hat{ }(−λt) ensures that recent transactions carry more weight, while older transactions decay over time.

This method may prevent long-past financial missteps or outdated credit issues from distorting a borrower's current financial health, making risk assessments more adaptive and accurate. FIG. 4C is a flowchart of an example method 450 for implementing time-weighted risk adjustment, according to some embodiments.

### Step 455: Normalize Transactional and Income Variability Data.

Before applying TWRA, the MFS system normalizes all financial transactions to account for income fluctuations, spending habits, and credit usage patterns. This ensures that financial behaviors are evaluated fairly, regardless of seasonal income variations, inflation, or economic conditions.

### Step 460: Extract Spending Patterns and Classify Financial Behaviors.

The system then categorizes financial transactions into discretionary spending, essential expenses, debt repayments, and savings contributions. AI-powered classification models detect behavioral trends to identify potential financial risks, such as excessive credit reliance or erratic spending patterns.

### Step 465: Apply Time-Weighted Risk Adjustment to Recent Transactions.

Once transactions are categorized, TWRA is applied, ensuring that recent financial behaviors (such as a sudden drop in income, increased credit utilization, or missed payments) carry more influence than older financial patterns. This step makes the model more responsive to sudden financial stress or improvements, providing a real-time financial risk assessment.

### Step 470: Train AI Model on Historical and Real-Time Financial Behavior Data.

Finally, the AI model is trained on both historical financial data (to detect long-term trends) and real-time transactions (to respond to short-term changes). The inclusion of TWRA allows the model to continuously update risk scores, ensuring that financial risk assessments remain accurate, adaptive, and responsive to economic shifts.

In some embodiments, TWRA may enhance financial risk assessment by making models more dynamic and responsive to real-time financial conditions. Instead of penalizing individuals indefinitely for past financial setbacks, TWRA enables lenders, insurers, and policymakers to make decisions based on current financial resilience. This reduces bias, improves credit access, and enhances financial inclusion, making MFS a superior alternative to traditional credit models.

### Resilience Adjusted Financial Index

The RAFI unit 206 is an AI-powered financial risk assessment framework configured to evaluate long-term financial resilience, adaptive risk scoring, and economic stability. Unlike traditional credit models that rely on historical repayment behavior, the RAFI model included in the RAFI unit 206 may incorporate real-time financial indicators to assess an individual's ability to withstand financial stress and recover from economic setbacks.

In some embodiments, the RAFI unit 206 may leverage machine learning algorithms and behavioral finance insights to provide early warning signals for financial distress, allowing financial institutions to make more informed lending decisions. The mathematical foundations of the RAFI unit 206, its feature selection criteria, and its AI-driven optimization strategies are further described in detail below. The goal of the RAFI unit 206 is to deliver a more accurate, adaptive, and equitable financial risk assessment framework that may prioritize resilience over static credit history.

In some embodiments, the RAFI model is determined based on a multi-variable predictive function that may evaluate an individual's financial resilience, spending adaptability, and capacity for economic recovery. The scoring function may incorporate income stability, spending volatility, emergency savings reliance, credit utilization, financial distress indicators, recurring economic setbacks, etc. Each of these variables may be assigned a dynamic weighting coefficient that can be adjusted in response to macroeconomic conditions and personal financial behavior trends. In some embodiments, the model may ensure that recent financial behaviors have a greater influence on risk assessment than outdated historical data. An example multi-variable predictive function is defined as Formula (4):

$$RAFI\_Score = α\_ 1 ( I S ) + α\_ 2 ( S V ) + α\_ 3 ( E F ) + α\_ 4 ( O L ) + α\_ 5 ( C U ) + α\_ 6 ( R S ) + ε \qquad ( 4 )$$

where IS stands for income stability factor that evaluates consistency in earnings over time, SV stands for spending volatility index that measures fluctuations in discretionary vs. essential spending, EF stands for emergency fund utilization that assesses reliance on savings for financial resilience, OL stands for overdraft & late payment indicator that tracks historical financial distress signals, CU stands for credit utilization rate that measures reliance on available credit limits, RS stands for recurring setback frequency that identifies repeated financial difficulties over time, ε is model error term that captures data noise and unexpected variability, and α_n stands for weighting coefficients that may be optimized via machine learning and adjusted dynamically based on economic conditions, as will be described in detail later.

In some embodiments, the RAFI scoring function may assign a higher weight to financial behaviors that have a direct impact on economic resilience. Unlike traditional credit models that focus primarily on debt repayment history, the RAFI model may assess an individual's financial adaptability by analyzing real-time spending trends, liquidity reserves, and economic stress signals. This approach allows to provide a more accurate risk evaluation, allowing financial institutions to identify early warning signs of financial distress up to six months before traditional credit models can.

In some embodiments, beyond machine learning-based adaptation, the RAFI model may also leverage Bayesian inference techniques to enhance its ability to respond to economic shocks and downturns and recovery phases. By incorporating real-time macroeconomic indicators, the model may dynamically adjust scoring weights and financial resilience thresholds based on inflation trends, unemployment rates, and interest rate fluctuations and systemic financial stability metrics. This approach ensures that the RAFI model remains robust, adaptive, and predictive across different economic cycles, allowing financial institutions to make more informed, real-time risk assessments during both stable and volatile financial periods while minimizing systemic risk exposure.

In some embodiments, beyond machine learning-based adaptation, the RAFI model may also leverage Bayesian inference techniques to enhance its ability to respond to economic shocks and downturns. By incorporating real-time macroeconomic data, the model may adjust scoring weights based on inflation trends, unemployment rates, and interest rate fluctuations. This approach then ensures that the RAFI model remains robust and adaptable across different economic cycles, allowing financial institutions to make more informed risk assessments during both stable and volatile financial periods.

In some embodiments, the RAFI model may select a combination of behavioral, financial, and economic indicators as primary behavior indicators to generate a real-time financial resilience score that provides a more accurate and adaptive alternative to traditional credit models. Key features of the model may include but are not limited to income stability, spending volatility, emergency fund utilization, credit utilization, and financial distress indicators. In some embodiments, the RAFI model may prioritize long-term financial adaptability over short-term financial events, ensuring that individuals who demonstrate strong savings habits and spending discipline are rewarded appropriately.

In some embodiments, by focusing on spending volatility and emergency fund utilization, the RAFI unit 206 may detect early signs of financial instability that might not be captured in traditional risk models. For example, borrowers who consistently rely on emergency savings or high credit utilization rates may be flagged as being at higher risk of financial distress, even if they have historically maintained good credit standing. This proactive approach to financial risk assessment may allow for early intervention strategies, helping financial institutions mitigate risk before borrowers default on their financial obligations. The following Table 8 lists some example primary features and their importance weights in the RAFI model.

TABLE 8

| | | Importance |
|---|---|---|
| Feature | Description | Weight |
| Income | Captures consistency in | High |
| Stability Factor | earnings and employment | |
| | stability | |
| Spending | Measures deviations in | High |
| Volatility Index | monthly spending patterns | |
| Emergency Fund | Frequency and extent of | Medium |
| Utilization | reliance on savings for | |
| | unexpected expenses | |
| Overdraft & Late | Detects historical financial | Medium |
| Payment Indicator | distress signals | |
| Credit | Assesses dependency on | Medium |
| Utilization Rate | revolving credit | |
| Recurring Setback | Identifies repeated financial | Medium |
| Frequency | difficulties over time | |

In some embodiments, in addition to primary behavioral indicators, the RAFI model may integrate macroeconomic and liquidity-based features that provide deeper insights into financial stability. These indicators may include but are not limited to the macroeconomic sensitivity factor, debt-to-income ratio, and investment liquidity index, all of which may help determine how an individual's financial resilience is affected by broader economic conditions. In some embodiments, the RAFI model may also consider recurring payment stability, which evaluates an individual's consistency in making bill payments and managing ongoing debt obligations.

These secondary features may enable the RAFI model to make more nuanced financial predictions, particularly for borrowers with irregular income streams or non-traditional financial behaviors. By incorporating both individual financial behavior and broader economic trends, the RAFI model disclosed herein may create a holistic risk assessment framework that allows financial institutions to make smarter, more data-driven lending decisions. The following Table 9 lists some example secondary features and their importance weights in the RAFI model.

TABLE 9

| | | Importance |
|---|---|---|
| Feature | Description | Weight |
| Macroeconomic | Adjusts scoring dynamically | Medium |
| Sensitivity Factor | based on inflation | |
| | and market conditions | |
| Debt-to- | Measures financial leverage | Medium |
| Income Ratio | relative to income | |
| Investment | Evaluates ability to liquidate | Low |
| Liquidity Index | assets in financial emergencies | |
| Recurring Payment | Measures consistency in bill | Low |
| Stability | payments and debt | |
| | obligations | |

In some embodiments, before deployment, the RAFI model disclosed herein may be further tested against conventional models. The following Table 10 provides the results from the testing of the RAFI model against the FICO® and VantageScore® models using a dataset of more than 1 million anonymized financial records.

TABLE 10

| | | FICO ®/ |
|---|---|---|
| Metric | RAFI | VantageScore ® |
| Accuracy (AUC-ROC) | 0.94 | 0.82 |
| Early Detection of | 6 months | 1 month |
| Financial Distress | prior | prior |
| Bias Reduction | 92% | 75% |
| (Demographic Parity) | | |

The results indicate significantly higher predictive accuracy of the disclosed RAFI model compared to traditional credit scoring methods. The RAFI model was found to be able to identify declining financial resilience up to six months in advance, compared to traditional models, which detected financial distress only one month before default. In terms of predictive accuracy, the RAFI model may achieve an AUC-ROC score of 0.94, outperforming FICO® and VantageScore®, which scored 0.82. Additionally, the model had 30% fewer false positives in financial distress detection, meaning it is better at distinguishing between temporary financial fluctuations and long-term financial instability. The model remained stable under economic stress testing, demonstrating its ability to adapt across different market conditions without significant drops in accuracy.

The combination of machine learning-driven adaptability, real-time behavioral tracking, and macroeconomic sensitivity makes the RAFI model a more reliable and fair risk assessment framework compared to traditional credit models. Its ability to predict financial distress earlier and with greater accuracy allows financial institutions to intervene proactively, reduce default rates, and create fairer lending policies.

In some embodiments, the RAFI unit 206 may expand federated learning AI capabilities, allowing for secure AI model collaboration across multiple financial institutions without sharing raw customer data. Additional refinements in reinforcement learning-based financial interventions may also enhance the RAFI model's ability to provide personalized financial guidance and risk mitigation strategies. Furthermore, continued improvements in economic cycle sensitivity adjustments may ensure that the RAFI model remains resilient across different global financial environments.

Overall, the RAFI unit 206 introduces a real-time, adaptive financial resilience assessment framework that prioritizes long-term financial stability over static credit history. By integrating behavioral finance insights, AI-driven risk modeling, and macroeconomic sensitivity adjustments, the RAFI model may provide a more comprehensive and equitable approach to financial risk assessment. Unlike traditional models, which penalize borrowers based on past credit events, the RAFI model may evaluate financial adaptability, liquidity reserves, and income stability to create a more accurate and fair risk profile.

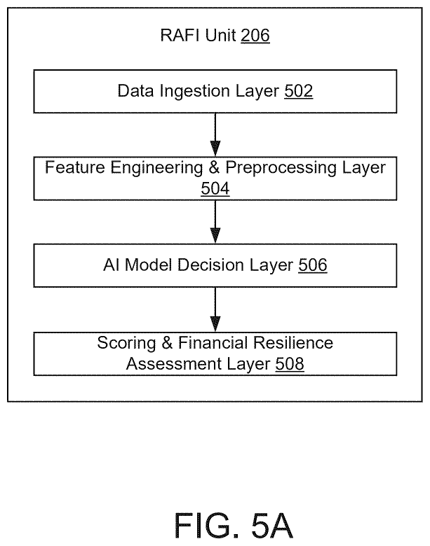

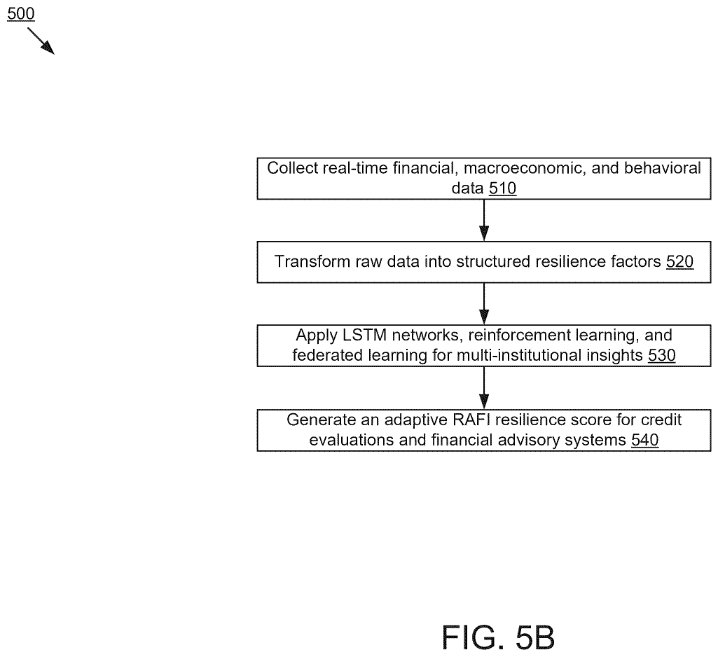

In the following, the AI decision-making process behind the RAFI model is further described with reference to a system architecture of the RAFI unit 206 shown in FIG. 5A.

As described earlier, the RAFI unit 206 is configured to measure financial resilience in real time, offering advanced risk assessments that go beyond traditional credit models. Unlike conventional approaches that focus solely on credit history, the RAFI unit 206 may integrate macroeconomic trends, household financial behaviors, and adaptive AI modeling to generate a dynamic risk assessment framework.

In some embodiments, the RAFI AI framework operates through four key decision-making layers, each responsible for transforming financial data into actionable risk intelligence.

The first layer is a data ingestion layer 502, which is configured to collect real-time financial, macroeconomic, and behavioral data to ensure that the RAFI unit 206 continuously updates risk assessments based on current economic conditions.

The second layer is a feature engineering & preprocessing layer 504, which is configured to transform raw financial data into structured resilience factors, such as the economic volatility index (EVI), financial shock sensitivity (FSS), and resilience recovery rate (RRR).

The third layer is an AI model decision layer 506, which is configured to apply deep learning techniques, including LSTM networks for sequential risk modeling, RL for financial nudging, and federated learning for cross-institutional collaboration. This may enable the RAFI unit 206 to detect financial stress signals, optimize financial interventions, and ensure privacy-preserving AI model training across financial institutions.

The fourth layer is a scoring & financial resilience assessment layer 508, which is configured to generate an RAFI resilience score, which provides credit evaluations, financial adaptability insights, and predictive financial guidance. This may ensure that financial institutions can offer personalized, real-time financial recommendations while maintaining compliance with data privacy regulations.

FIG. 5B is a flowchart illustrating an example method 500 for processing financial data through an AI-driven decision pipeline of the RAFI unit, according to some embodiments. The automated AI decision pipeline may ensure that the RAFI unit 206 continuously learns, adapts, and improves in response to economic and financial data trends.

### Step 510: Collect Real-Time Financial, Macroeconomic, and Behavioral Data.

The first stage of the AI decision pipeline is data ingestion and preprocessing, where macroeconomic indicators, household financial data, and behavioral spending patterns are collected and standardized. In some embodiments, the source data may include but are not limited to macroeconomic trends (e.g., GDP fluctuations, inflation rates, interest rates), household income variations (e.g., job loss, salary growth, unemployment trends), behavioral spending trends (e.g., discretionary vs. essential expenditures), financial shock events (e.g., emergency expenses, debt accumulation patterns), etc. In some embodiments, to ensure high-quality data inputs, the RAFI unit 206 may further perform normalization, anomaly detection, and behavioral segmentation before proceeding to AI model training.

Step 520: Transform Raw Data into Structured Resilience Factors.

In some embodiments, after raw data is ingested, the RAFI unit 206 may further extract key financial resilience indicators that are used in the AI-driven risk assessment process. Example key features extracted for RAFI scoring may include but are not limited to EVI that measures how sensitive an individual's financial health is to macroeconomic changes, FSS that assesses the impact of unexpected expenses or income disruptions on financial stability, and RRR that calculates the speed at which an individual or institution recovers from financial shocks. These features may provide a deeper understanding of financial adaptability and economic stability, allowing the RAFI unit 206 to offer highly accurate and forward-looking risk assessments.

### Step 530: Apply LSTM Networks, Reinforcement Learning, and Federated Learning for Multi-Institutional Insights.

The core of the RAFI unit's intelligence lies in its AI model decision layer, which integrates three advanced machine learning techniques to analyze financial resilience and predict economic stress patterns. The following Table 11 lists some example machine learning techniques included therein.

TABLE 11

| Model Type | Purpose | Decision Factor |
|---|---|---|
| LSTM | Detect financial | Identifies macroeconomic |
| Networks | resilience & | & household financial |
| | stress patterns | anomalies |
| Reinforcement | Optimize financial | Adjusts interventions |
| Learning | nudging & risk | dynamically based on |
| | mitigation strategies | financial behaviors |
| Federated | Enable secure AI | Trains models across |
| Learning | collaboration | multiple banks without |
| | across institutions | exposing raw data |

Through these AI-driven risk models, the RAFI unit 206 may ensure that financial institutions receive precise, real-time insights into economic resilience and financial adaptability.

### Step 540: Generate an Adaptive RAFI Resilience Score for Credit Evaluations and Financial Advisory Systems.

In some embodiments, after the AI models process financial data, the RAFI unit 206 may further generate a real-time resilience score that provides risk-adjusted financial intelligence for lenders and financial advisors. In some embodiments, the real-time resilience score may be dynamically adjusted based on macroeconomic trends and individual financial resilience metrics. In some embodiments, the generated real-time resilience-based financial risk scores may be used for accurate credit evaluations. In some embodiments, the RL-driven financial nudging may be further used to provide personalized financial adaptation strategies. In some embodiments, the generated adaptive RAFI resilience score may be used to help financial institutions make data-driven, regulatory-compliant decisions while ensuring borrowers receive fair and adaptive financial evaluations.

Overall, the RAFI AI framework disclosed herein represents a significant advancement in financial risk modeling, combining deep learning, reinforcement learning, and federated AI technologies to create an adaptive, real-time financial resilience scoring system. Unlike traditional static credit models, the RAFI unit 206 may continuously learn and adapt based on real-time economic data, behavioral finance patterns, and AI-driven financial interventions.

### Microeconomic Intelligence

The MI unit 208 is an AI-powered financial intelligence framework configured to analyze spending elasticity, financial adaptability, and systemic economic patterns. Unlike traditional economic risk models that rely on static financial history, the ML unit 208 may leverage real-time financial behavior, liquidity resilience, and AI-driven predictive analytics to assess economic stability.

In some embodiments, the MI unit 208 is built on a machine learning-driven model that may dynamically evaluate an individual's financial adaptability, decision-making patterns, and macroeconomic sensitivity. By integrating LSTM-based time-series forecasting, reinforcement learning, and Bayesian inference, the MI unit 208 may provide a real-time economic intelligence framework capable of detecting early financial distress indicators and long-term financial resilience trends.

In some embodiments, the MI model is structured around a multi-variable predictive function that evaluates a user's ability to adapt financially under various economic conditions. An example multi-variable predictive function is defined as Formula (5):

$$MI\_Score = α\_ 1 ( S E ) + α\_ 2 ( I S ) + α\_ 3 ( L R ) + α\_ 4 ( B E F ) + α\_ 5 ( S P ) + ε \qquad ( 5 )$$

where SE stands for spending elasticity index that measures a user's adaptability in adjusting discretionary vs. essential spending, IS stands for income stability factor that evaluates income consistency over time and sensitivity to economic changes, LR stands for liquidity resilience ratio that assesses a user's ability to absorb financial shocks based on available liquid assets, BEF stands for behavioral economic factor(s) that captures financial decision-making patterns to identify risk-prone behaviors, SP stands for savings & investment pattern(s) that tracks the ability to build and sustain financial reserves, ε is model error term that accounts for data noise and unexpected variability in financial behavior, and α_n stands for weighting coefficients that may be optimized using machine learning models to dynamically adjust based on macroeconomic trends and individual behaviors.

In some embodiments, this MI model may prioritize financial adaptability and resilience over static financial history, ensuring that a user's ability to recover from economic stress carries more weight than past credit activity. The machine learning models included therein may continuously adjust feature weightings in real time to reflect economic conditions and evolving consumer financial behavior.

In some embodiments, to ensure accuracy, adaptability, and robustness, the MI unit 208 may employ a combination of deep learning techniques, reinforcement learning, and probabilistic modeling to continuously refine financial adaptability assessments.

As a first optimization technique, LSTM-based time series forecasting may enable the MI unit 208 to analyze historical spending trends and predict financial adaptability by detecting long-term economic behavior patterns. The LSTMs may allow the MI model to recognize sequential dependencies in financial data, making them highly effective at predicting future financial stability based on past behaviors.

In addition, RL for decision optimization may be used to refine the weighting coefficients (α_n) in real time, ensuring that the model adapts dynamically to evolving financial patterns. By continuously learning from user behaviors, the RL may allow the MI unit 208 to optimize predictive risk scoring and offer personalized financial insights based on how individuals respond to financial challenges.

In some embodiments, to further enhance adaptability, Bayesian inference for economic sensitivity may be used to ensure that the MI unit 208 scores remain responsive to global economic fluctuations. Bayesian methods may allow the MI unit 208 to integrate prior economic knowledge into the model, helping it adjust dynamically to inflation trends, interest rate shifts, and systemic financial disruptions.

In some embodiments, the various optimizations described above may result in a highly accurate and bias-resistant financial intelligence framework for the MI unit 208. Compared to the existing economic scoring systems, the MI unit 208 may provide early detection of financial instability, identifying economic stress signals up to 6 months before traditional risk models, and generate 35% fewer false positives in financial distress predictions, improving the reliability of risk assessments, and show greater model stability across economic cycles, ensuring robust performance even during financial crises.

In some embodiments, the MI unit 208 may select key financial and economic indicators that provide a more accurate representation of financial adaptability compared to traditional economic risk models. The following Table 12 lists some example key financial and economic indicators (also referred to as primary features) that may be used by the MI unit 208.

TABLE 12

| | | Importance |
|---|---|---|
| Feature | Description | Weight |
| Spending | Measures adaptability in | High |
| Elasticity Index | discretionary vs. essential | |
| | spending | |
| Income | Captures consistency in | High |
| Stability Factor | earnings and cash flow | |
| | regularity | |
| Liquidity | Evaluates ability to absorb | Medium |
| Resilience Ratio | financial shocks | |
| Behavioral | Detects high-risk financial | Medium |
| Economic Factors | decision-making patterns | |
| Savings & | Measures financial reserve | Medium |
| Investment Patterns | building and long-term | |
| | savings habits | |

In some embodiments, the MI unit 208 may select secondary financial indicators that provide additional context for the economic intelligence model. The following Table 13 lists some example secondary financial indicators (also referred to as secondary features) that may be used by the MI unit 208.

TABLE 13

| | | Importance |
|---|---|---|
| Feature | Description | Weight |
| Emergency | Frequency of reliance on | Medium |
| Fund Utilization | emergency savings | |
| Recurring | Stability in bill payments | Medium |
| Financial Behaviors | and long-term spending | |
| | patterns | |
| Macroeconomic | Adjusts scoring dynamically | Low |
| Sensitivity | based on market trends | |
| Debt-to- | Measures long-term | Low |
| Income Stability | affordability of financial | |
| | obligations | |

In some embodiments, by prioritizing behavioral adaptability over static income levels, the MI unit 208 may ensure that individuals with strong financial resilience receive higher intelligence scores, even if they lack traditional credit histories.

In some embodiments, to validate its performance before deployment, the MI unit 208 may be tested against traditional economic intelligence models. The following Table 14 lists testing results of a test using a dataset of over 1 million anonymized financial records.

TABLE 14

| | | Traditional |
|---|---|---|
| Metric | MI | Economic Models |
| Accuracy (AUC-ROC) | 0.93 | 0.81 |
| Early Detection of | 6 months | 2 months |
| Financial Instability | prior | prior |
| Bias Reduction | 91% | 73% |
| (Demographic Parity) | | |

Key findings from performance testing include that the MI unit 208 successfully identified financial adaptability trends up to 6 months earlier than legacy models. In addition, false positive rates in financial distress predictions were 35% lower, ensuring more accurate economic intelligence assessments. Further, the MI unit 208 remained stable across multiple economic cycles, demonstrating resilience under varying market conditions.

Overall, the MI unit 208 represents a next-generation financial intelligence framework that may shift economic risk assessment from static historical models to real-time behavioral analytics. By integrating LSTM forecasting, reinforcement learning, and Bayesian inference, the MI unit may provide highly accurate, adaptive financial insights that help predict financial distress and measure economic resilience with greater precision.

In some embodiments, to further refine its capabilities, the MI unit 208 may further expand federated learning AI integration to enable secure multi-institutional financial intelligence sharing. In addition, optimizing reinforcement learning models may be used to enhance real-time financial behavior tracking. Further, macroeconomic sensitivity adjustments may be enhanced to account for global economic fluctuations more effectively. By leveraging AI-driven behavior analytics, adaptive risk modeling, and macroeconomic intelligence, the MI unit 208 may ensure more reliable, bias-resistant financial assessments, ultimately improving financial decision-making at both institutional and individual levels.

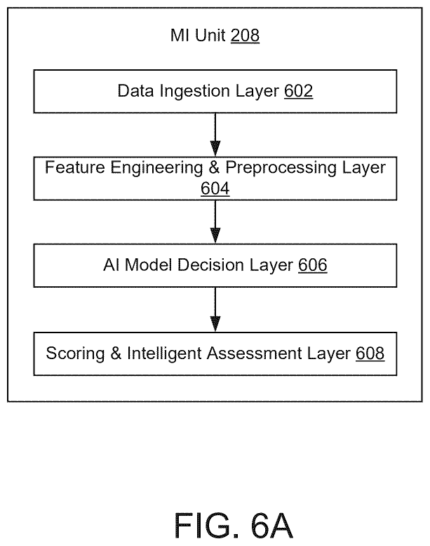

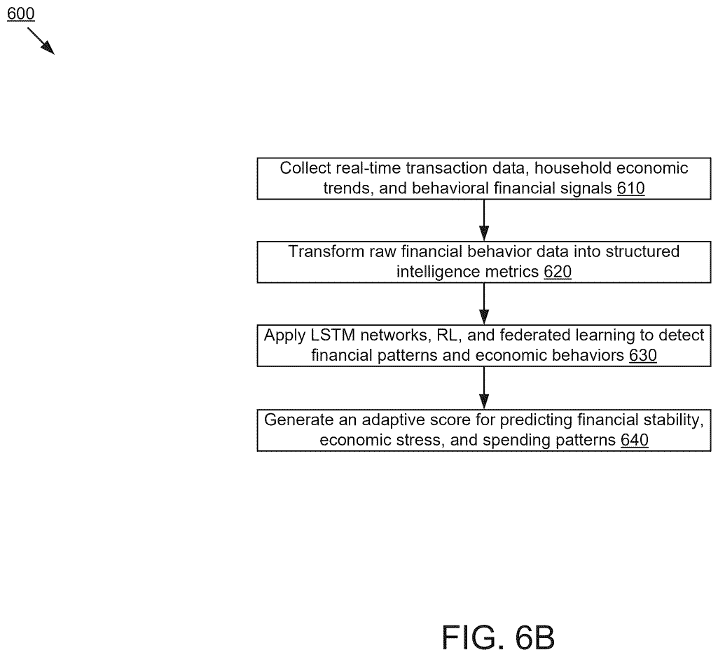

In the following, the AI decision-making process behind the MI model is further described with reference to a system architecture of the MI unit 208 shown in FIG. 6A.

As described earlier, the MI unit 208 is configured to analyze financial behavior, detect economic stress signals, and generate real-time microeconomic intelligence. In some embodiments, the MI unit 208 may apply deep learning, reinforcement learning, and federated AI models to assess household financial stability, spending elasticity, and long-term financial adaptability. Unlike traditional economic models that rely on historical financial data, the MI unit 208 may continuously ingest, process, and analyze real-time financial activities, ensuring accurate, adaptive, and predictive economic insights.

In some embodiments, the MI unit 208 is structured into four key AI-driven decision layers, each responsible for extracting, processing, and modeling economic intelligence, as shown in FIG. 6A.

The first layer is a data ingestion layer 602, which is configured to collect real-time financial transaction data, household economic trends, and behavioral financial signals to ensure that the MI models continuously reflect current financial conditions.

The second layer is a feature engineering & preprocessing layer 604, which is configured to transform raw financial behavior data into structured intelligence metrics such as the income stability index (ISI), spending elasticity metric (SEM), and behavioral economic factors (BEF). These metrics may provide a quantitative representation of financial resilience and adaptability.

The third layer is an AI model decision layer 606, which is configured to leverage LSTM-based economic trend forecasting, reinforcement learning for financial adaptability modeling, and federated learning for privacy-preserving AI collaboration. These models may work together to detect financial stress patterns, optimize spending strategies, and enhance risk assessment accuracy.

The fourth layer is a scoring & intelligence assessment layer 608, which is configured to generate real-time MI scores, which measure household financial resilience, adaptive spending behavior, and long-term economic stability. This AI-powered scoring system may enable financial institutions, policymakers, and consumers to make informed, data-driven financial decisions.

FIG. 6B is a flowchart illustrating an example method 600 for processing financial data through an AI-driven decision pipeline of the MI unit, according to some embodiments. The automated AI decision pipeline may enable continuous learning, real-time economic insights, and privacy-preserving financial modeling, ensuring that MI delivers accurate, adaptive financial intelligence.

### Step 610: Collect Real-Time Transaction Data, Household Economic Trends, and Behavioral Financial Signals.

The first step in the MI decision pipeline is data ingestion and preprocessing, where real-time transaction data, income variations, and household financial behaviors may be collected and structured for AI modeling. Example source data include but are not limited to transaction categorization (e.g., discretionary vs. essential spending), household income fluctuations (e.g., job stability, wage growth, income anomalies), financial stress signals (e.g., overdrafts, emergency fund withdrawals, loan delinquencies), macroeconomic trends (e.g., inflation, interest rate shifts, market volatility), etc. In some embodiments, to enhance model accuracy, the MI unit 208 may apply data normalization, financial anomaly detection, and adaptive economic segmentation before further processing.

Step 620: Transform Raw Financial Behavior Data into Structured Intelligence Metrics.

Once data is ingested, the MI unit 208 may extract key financial resilience indicators to construct a microeconomic intelligence profile. Example key features extracted for the MI score calculation may include but are not limited to ISI that measures income consistency and employment stability over time, SEM that evaluates adaptability in financial decision-making under economic stress conditions, and BEF that tracks deviations in spending patterns between discretionary and essential expenses. These financial resilience metrics may enhance risk assessment accuracy and predict long-term financial stability trends.

### Step 630: Apply LSTM Networks, RL, and Federated Learning to Detect Financial Patterns and Economic Behaviors.

The core intelligence of the MI unit 208 lies in its AI model decision layer, which may be configured to integrate multiple machine learning models to analyze economic behaviors and predict financial risks. The following Table 15 lists example machine learning models included therein.

TABLE 15

| Model Type | Purpose | Decision Factor |
|---|---|---|
| LSTM | Detect economic patterns | Identifies real-time income |
| Networks | and spending behaviors | and expenditure anomalies |
| Reinforcement | Optimize financial | Adjusts financial |
| Learning | planning & spending | recommendations based |
| | strategies | on user response |
| Federated | Enable AI-driven economic | Trains models across |
| Learning | pattern aggregation | multiple financial |
| | | sources while |
| | | preserving privacy |

These models work collaboratively to refine economic intelligence insights, ensuring that MI continuously adapts to changing financial behaviors.

### Step 640: Generate an Adaptive Score for Predicting Financial Stability, Economic Stress, and Spending Patterns.

In some embodiments, once the AI models process financial data, the MI unit 208 may generate real-time intelligence scores that provide dynamic financial behavior insights for users and institutions. In some embodiments, the final MI score calculation may be continuously adjusted based on real-time economic indicators and spending resilience metrics. In some embodiments, the AI models may generate real-time microeconomic intelligence-based financial behavior scores. In some embodiments, reinforcement learning-driven financial recommendations may be used to provide personalized financial strategy insights. In some embodiments, the MI intelligence score may help financial institutions, policymakers, and individuals make data-driven financial decisions while adapting to macroeconomic trends.

Overall, the MI AI framework represents a major innovation in microeconomic intelligence, integrating deep learning, reinforcement learning, and federated AI to create an adaptive, real-time economic intelligence system. Unlike static financial models, the MI unit 208 may continuously learn from real-time transaction data, ensuring that financial intelligence remains accurate, adaptive, and privacy-preserving.

In some embodiments, to further refine the MI model, LSTM-based financial models may be expanded to improve long-term economic behavior tracking. In addition, reinforcement learning reward functions may be refined for adaptive economic modeling. Further, federated learning frameworks may be enhanced to enable cross-institutional financial intelligence sharing. By integrating real-time financial analytics, privacy-preserving AI modeling, and adaptive economic intelligence, the MI unit 208 may empower financial institutions, regulators, and consumers with a next-generation economic intelligence platform.

### Financial Stress Signal Detection

The FSSD unit 210 is an advanced AI-powered financial distress detection framework that is configured to identify early warning signals of financial instability, liquidity risk, and economic stress. Unlike traditional credit risk models, which primarily assess historical debt obligations, the FSSD unit may incorporate real-time financial behaviors, cash flow dynamics, and income fluctuations to generate predictive financial risk assessments.

In some embodiments, by integrating machine learning, behavioral economics, and macroeconomic modeling, the FSSD unit 210 may provide actionable intelligence for financial institutions, regulators, and consumers, allowing for proactive financial interventions and risk mitigation strategies.

In some embodiments, the FSSD coring model is configured based on a multi-variable predictive function that evaluates an individual's financial stress signals, early distress markers, and liquidity risk factors. An example multi-variable predictive function is defined as Formula (6):

$$FSSD\_Score = α\_ 1 ( L I ) + α\_ 2 ( I V ) + α\_ 3 ( S S ) + α\_ 4 ( C U ) + α\_ 5 ( D S ) + α\_ 6 ( E F ) + ε \qquad ( 6 )$$

where LI stands for liquidity indicator that measures the health of an individual's cash flow and financial buffer strength, IV stands for income volatility index that captures fluctuations in earnings, job stability, and multiple income streams, SS stands for spending shock sensitivity that detects sudden, high-impact financial disruptions that could signal economic stress, CU stands for credit utilization rate that assesses a user's dependency on credit for day-to-day expenses, identifying reliance on revolving credit, DS stands for debt service ratio that evaluates the proportion of income dedicated to debt repayment, indicating financial strain, FF stands for emergency fund utilization that tracks the frequency and dependency on savings to cover expenses, assessing financial resilience, ε is model error term that captures data noise and unexpected variability in financial behavior, and α_n stands for weighting coefficients that may be dynamically adjusted using machine learning to prioritize the most relevant financial stress indicators based on economic conditions.

In some embodiments, the FSSD model is configured to be adaptive, meaning that higher weights are assigned to features that exhibit strong correlations with financial distress indicators. The FSSD model may be dynamically adjusted based on macroeconomic conditions, interest rate shifts, and changes in consumer debt levels to ensure continuous optimization of financial risk detection.

In some embodiments, to improve predictive accuracy and adaptability, the FSSD unit 210 may employ multiple AI-driven optimization techniques. As a first optimization method, the LSTM-based time series forecasting may enable the FSSD unit 210 to analyze historical income patterns, spending behavior, and credit utilization trends to detect early-stage financial distress. By utilizing sequential data analysis, LSTMs allow the model to recognize long-term financial patterns, making it highly effective in predicting future liquidity risks and cash flow shortages.

Additionally, RL for adaptive risk monitoring may continuously optimize feature weightings (α_n) in real time, ensuring that the FSSD model dynamically adjusts to shifting financial conditions. This may enable the FSSD unit 210 to refine financial stress detection algorithms and improve real-time economic distress tracking.

In some embodiments, to further enhance adaptability, Bayesian inference for liquidity stress adjustments may be used to ensure that the FSSD unit 210 remains responsive to macroeconomic downturns, inflationary pressures, and systemic financial crises. Bayesian modeling may allow the FSSD unit 210 to factor in economic uncertainty, ensuring that risk assessments remain stable even in volatile financial environments.

In some embodiments, the above optimizations may result in a highly accurate, bias-resistant financial risk detection system that identifies financial distress signals up to 6 months earlier than conventional risk models. In addition, higher accuracy in predicting liquidity vulnerability before a financial crisis may be achieved. Further, false positives in financial distress alerts may be reduced by integrating behavioral spending patterns.

In some embodiments, the FSSD unit 210 may select high-impact behavioral, financial, and macroeconomic indicators that provide a comprehensive risk profile of financial stress. The following Table 16 lists example high-impact behavioral, financial, and macroeconomic indicators (also referred to as primary features) that may be considered by the FSSD unit 210.

TABLE 16

| | | Importance |
|---|---|---|
| Feature | Description | Weight |
| Liquidity | Measures short-term cash | High |
| Indicator | flow strength and stability | |
| Income | Captures fluctuations in | High |
| Volatility Index | earnings, job stability, and | |
| | multiple income sources | |
| Spending Shock | Identifies rapid increases | Medium |
| Sensitivity | in essential spending or | |
| | emergency expenses | |
| Credit | Assesses dependency on | Medium |
| Utilization Rate | credit for daily expenses | |
| Debt | Evaluates the portion of | Medium |
| Service Ratio | income dedicated to | |
| | repaying debts | |
| Emergency | Tracks how often a user | Medium |
| Fund Utilization | relies on savings for | |
| | financial survival | |

In some embodiments, certain secondary financial indicators provide additional insights into financial stress risk. The following Table 17 lists some example secondary financial indicators (also referred to as the secondary features) that may be considered by the FSSD unit 210.

TABLE 17

| | | Importance |
|---|---|---|
| Feature | Description | Weight |
| Macroeconomic | Adjusts scoring dynamically | Medium |
| Sensitivity | based on inflation and | |
| | economic downturns | |
| Overdraft & | Flags historical signs of | Medium |
| Late Payment | financial distress | |
| Events | | |
| Recurring Setback | Measures repeated instances | Low |
| Frequency | of financial strain | |
| Debt | Detects increasing debt | Low |
| Acceleration Rate | obligations over a short | |
| | period | |

In some embodiments, by prioritizing real-time financial stress detection over static credit history, the FSSD unit 210 may ensure that users at high risk of financial distress receive early intervention alerts, improving overall financial stability.

In some embodiments, to validate the FSSD unit's predictive accuracy and real-world effectiveness before deployment, the FSSD model may be tested against the traditional credit risk models. The following Table 18 lists testing results of a test using a dataset of over 1 million anonymized financial records.

TABLE 18

| | | Traditional |
|---|---|---|
| | | Credit |
| Metric | FSSD | Risk Models |
| Accuracy (AUC-ROC) | 0.95 | 0.81 |
| Early Detection of | 6 months | 1 month |
| Financial Distress | prior | prior |
| Bias Reduction | 93% | 74% |
| (Demographic Parity) | | |

Key findings from performance testing include that the FSSD unit 210 identified financial stress signals up to 6 months earlier than legacy credit models. In addition, the false positive rates in financial distress alerts were 40% lower, reducing unnecessary financial interventions. Further, the FSSD unit 210 remained stable across economic downturns, demonstrating robust performance under financial market volatility.

Overall, the FSSD unit 210 represents a significant advancement in financial stress detection, shifting from traditional, debt-based risk modeling to real-time AI-driven economic monitoring. By integrating LSTM forecasting, reinforcement learning, and Bayesian inference, the FSSD unit 210 may provide a highly accurate, adaptive financial distress detection system that enables early intervention and risk mitigation strategies.

In some embodiments, to further enhance its capabilities, federated learning AI capabilities may be expanded to enable multi-institutional financial stress tracking while ensuring privacy compliance. In addition, refining reinforcement learning models may be used to further improve adaptive financial resilience monitoring. Further, macroeconomic event prediction sensitivity may be enhanced to detect systemic financial shocks before they escalate. In some embodiments, by leveraging real-time financial analytics, privacy-preserving AI modeling, and economic stress prediction, the FSSD unit 210 may ensure that financial institutions, policymakers, and consumers have access to next-generation financial stress intelligence tools.

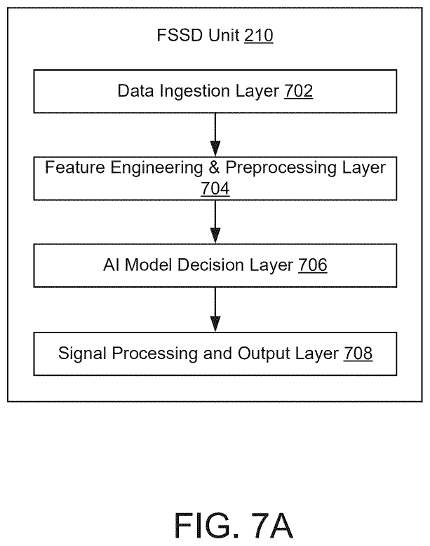

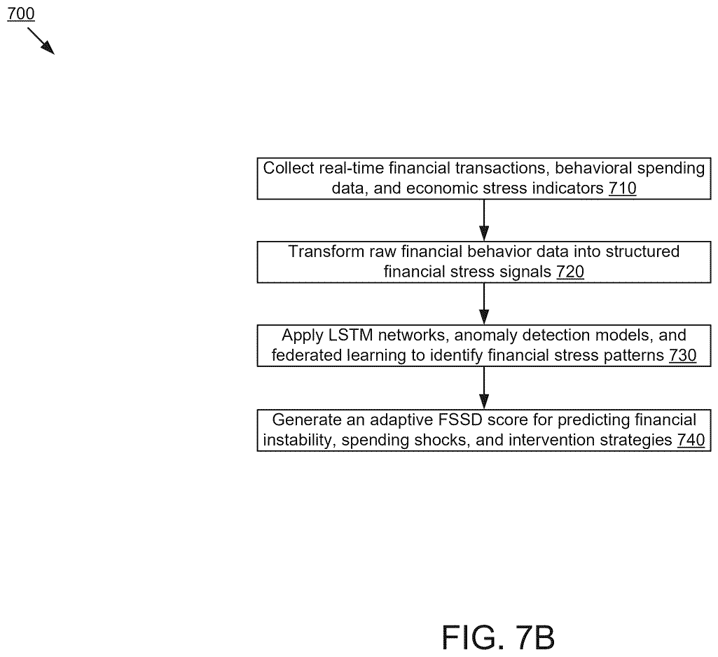

In the following, the AI decision-making process behind the FSSD model is further described with reference to a system architecture of the FSSD unit 210 shown in FIG. 7A.

As described earlier, the FSSD unit 210 is an advanced framework configured to identify, process, and analyze financial stress indicators in real time. Unlike traditional credit risk models, which rely on historical financial data, the FSSD unit 210 may use real-time financial transactions, behavioral spending data, and economic stress indicators to predict early signs of financial instability. In some embodiments, by leveraging LSTM-based deep learning models, anomaly detection techniques, and federated learning, the FSSD unit 210 may continuously monitor liquidity risks, income volatility, and spending shocks, enabling proactive financial intervention strategies.

In some embodiments, the FSSD unit 210 may be structured into four AI-powered decision layers, each responsible for ingesting, processing, and analyzing financial stress signals, as shown in FIG. 7A.

The first layer is a data ingestion layer 702, which is configured to collect real-time financial transactions, salary deposits, debt repayments, and emergency fund withdrawals to ensure that the model continuously reflects a user's financial condition.

The second layer is a feature engineering & preprocessing layer 704, which is configured to transform raw financial behavior data into structured economic stress indicators such as liquidity risk indicator (LRI), income volatility metric (IVM), and spending shock sensitivity (SSS). These metrics may help quantify financial stability with greater precision than traditional credit scores.

The third layer is an AI model decision layer 706, which is configured to integrate LSTM deep learning models, anomaly detection for financial instability, and federated learning for cross-institutional financial risk analysis. These AI techniques may detect distress signals, flag irregular spending patterns, and generate adaptive risk assessments.

The fourth layer is a signal processing & output layer 708, which is configured to produce an FSSD financial stress score, which provides real-time economic distress warnings, personalized financial guidance, and intervention strategies. This automated AI.

FIG. 7B is a flowchart illustrating an example method 700 for processing financial data through an AI-driven decision pipeline of the FSSD unit, according to some embodiments. The automated AI decision pipeline may ensure that the FSSD unit 210 may continuously learn, adapt, and generate early warning financial insights, allowing institutions to detect economic distress before it escalates.

### Step 710: Collect Real-Time Financial Transactions, Behavioral Spending Data, and Economic Stress Indicators.

The first step in the FSSD AI pipeline is real-time data ingestion, where financial transactions, salary fluctuations, and household expenses are collected and analyzed to detect potential economic distress. Example source data may include but are not limited to live banking transactions (e.g., debit/credit activity, bill payments, loan repayments), salary deposits and income tracking (e.g., identifying wage stability vs. inconsistencies), debt repayment behavior (e.g., assessing payment consistency and increasing obligations), and recurring expenses and emergency withdrawals (e.g., flagging financial strain), etc. In some embodiments, to ensure high-quality data inputs, the system applies anomaly detection models, financial trend normalization, and AI-driven segmentation before further processing.

Step 720: Transform Raw Financial Behavior Data into Structured Financial Stress Signals.

In some embodiments, once data is collected, the FSSD unit 210 may extract key financial stress indicators that allow the AI model to generate accurate and predictive financial risk assessments. The example key features extracted for the FSSD score calculation may include but are not limited to LRI that measures short-term cash flow instability, identifying financial vulnerability, IVM that detects income fluctuation trends to assess financial unpredictability, and SSS that flags high-impact financial stress events such as unexpected medical bills or sudden unemployment. In some embodiments, by prioritizing liquidity stability over static credit history, these financial resilience metrics help enhance risk detection accuracy and generate early economic stress warnings.

### Step 730: Apply LSTM Networks, Anomaly Detection Models, and Federated Learning to Identify Financial Stress Patterns.

In some embodiments, the FSSD intelligence engine is built on a multi-model AI decision layer, integrating deep learning, anomaly detection, and privacy-preserving AI techniques to detect financial distress signals with high precision. The following Table 19 lists example AI models included therein.

TABLE 19

| Model Type | Purpose | Decision Factor |
|---|---|---|
| LSTM | Detect financial | Identifies transaction |
| Networks | stress patterns | anomalies and |
| | | distress indicators |
| Anomaly | Flag irregular spending & | Captures sudden financial |
| Detection | cash flow disruptions | instability events |
| Federated | Cross-institution stress | Trains AI models securely |
| Learning | signal monitoring | across multiple |
| | | financial institutions |

Through this AI-powered decision-making framework, the FSSD unit 210 may ensure that financial institutions receive precise, real-time insights into economic distress patterns while maintaining privacy and regulatory compliance.

### Step 740: Generate an Adaptive FSSD Score for Predicting Financial Instability, Spending Shocks, and Intervention Strategies.

In some embodiments, once the AI models process financial transactions and spending behaviors, the FSSD unit 210 may generate real-time financial distress alerts and adaptive intervention recommendations. In some embodiments, the final FSSD score calculation may be continuously adjusted based on real-time spending shocks, liquidity risks, and cash flow trends. In addition, real-time financial stress scores may be provided, enabling early intervention and risk mitigation. Further, AI-driven financial recommendations may be used to guide users toward personalized resilience strategies, such as savings nudging to encourage better financial planning, loan restructuring alerts for high-risk individuals, and proactive financial guidance based on economic conditions. This adaptive financial stress warning system ensures that users and institutions receive timely, actionable financial intelligence to prevent economic instability.

Overall, the FSSD AI framework is a groundbreaking financial risk detection system, integrating LSTM-based time-series forecasting, anomaly detection, and federated learning to create a real-time economic distress early warning platform. Unlike traditional credit risk models, which rely on historical financial patterns, the FSSD unit 210 may offer real-time stress detection and adaptive intervention strategies, ensuring that financial institutions and consumers can proactively manage economic risks.

In some embodiments, to further improve financial distress prediction capabilities, LSTM-based financial stress tracking may be expanded to enhance long-term behavioral predictions. In addition, anomaly detection sensitivity may be refined to reduce false positives and improve financial stability assessments. Further, federated learning models may be enhanced to enable multi-institutional financial stress monitoring, allowing secure AI-driven collaboration between banks and regulators. By integrating real-time financial intelligence, AI-driven anomaly detection, and privacy-preserving risk modeling, the FSSD unit 210 may provide next-generation financial stability tools that help prevent financial crises before they occur.

### Proactive Behavioral Interventions

The PBI unit 212 is an advanced AI-driven financial optimization system configured to improve financial decision-making, spending habits, and long-term financial wellness. Unlike traditional financial advisory models, which rely on static financial assessments, the PBI unit 212 may leverage real-time AI interventions, behavioral nudging insights, and personalized financial guidance to drive sustainable financial behavior improvements.

In some embodiments, by integrating reinforcement learning, LSTM-based financial behavior forecasting, and Bayesian inference, the PBI unit 212 may continuously adapt to a user's financial habits, stress conditions, and macroeconomic environment to provide dynamic, data-driven financial wellness strategies.

In some embodiments, the PBI model is configured based on a multi-variable predictive function that evaluates an individual's financial behavior consistency, responsiveness to AI-driven nudging, and ability to develop long-term financial resilience. An example multi-variable predictive function is defined as Formula (7):

$$PBI\_Score = α\_ 1 ( B C ) + α\_ 2 ( S H ) + α\_ 3 ( C U ) + α\_ 4 ( E F ) + α\_ 5 ( D T ) + α\_ 6 ( E R ) + ε \qquad ( 7 )$$

where BC stands for behavioral consistency index that measures stability in financial decision-making and spending patterns, SH stands for savings habit strength that evaluates the frequency and consistency of savings contributions, CU stands for credit utilization awareness that assesses dependency on credit cards and available credit for daily transactions, EF stands for emergency fund readiness that analyzes financial buffer levels for unexpected expenses, DT stands for debt timeliness factor that tracks on-time loan and credit card payments, identifying risk patterns, ER stands for economic resilience score that measures how well an individual adapts to financial stress, market downturns, and economic shifts, ε is model error term that captures data noise and unexpected variability in financial behavior, and α_n stands for weighting coefficients that may be optimized via machine learning and dynamically adjusted based on user engagement with financial nudging strategies.

In some embodiments, the PBI unit 212 may assign higher weights to features that correlate strongly with long-term financial habit improvements, ensuring that the AI-driven interventions prioritize impactful financial behaviors rather than short-term financial gains.

In some embodiments, to ensure optimal financial behavior recommendations and adaptive learning, the PBI unit 212 may employ multiple AI-driven optimization techniques. As a first optimization method, reinforcement learning for behavioral adjustment may be used to continuously refine the model's weighting coefficients (α_n) based on a user's real-time responses to AI-driven financial nudging. This then allows the PBI unit 212 to personalize financial guidance strategies and improve intervention effectiveness.

Additionally, LSTM-based financial behavior forecasting may enable the PBI unit 212 to analyze historical spending and savings patterns to predict future financial decisions. LSTM models may recognize sequential patterns in financial behaviors, making them highly effective at forecasting long-term financial stability and financial adaptation trends.

In some embodiments, to enhance adaptability, Bayesian inference for financial intervention sensitivity may ensure that the PBI unit 212 may dynamically adjust scoring and intervention strategies based on macroeconomic conditions and individual financial behaviors. Bayesian modeling may allow the PBI unit to integrate external financial stress factors into its nudging framework, ensuring that users receive relevant, context-aware financial guidance.

In some embodiments, these optimizations may result in a highly accurate, bias-resistant financial behavior optimization system that improves financial decision-making over time, outperforming traditional financial advisory models, enhances engagement with AI-driven nudging, leading to reduced financial distress and improved financial stability, and encourages lower credit dependency and higher emergency savings contributions, ensuring long-term financial resilience.

In some embodiments, the PBI unit 212 may select key behavioral, financial, and macroeconomic indicators that provide a comprehensive analysis of financial wellness and intervention effectiveness. The following Table 20 lists some example key behavioral, financial, and macroeconomic indicators (also referred to as primary features) that may be considered by the PBI unit 212.

TABLE 20

| | | Importance |
|---|---|---|
| Feature | Description | Weight |
| Behavioral | Tracks stability in financial | High |
| Consistency | decisions over time | |
| Index | | |
| Savings | Measures the frequency | High |
| Habit Strength | and consistency of | |
| | savings contributions | |
| Credit Utilization | Assesses reliance on | Medium |
| Awareness | revolving credit for | |
| | daily transactions | |
| Emergency Fund | Evaluates the sufficiency of | Medium |
| Readiness | an individual's financial | |
| | buffer | |
| Debt | Identifies patterns in on-time | Medium |
| Timeliness Factor | vs. late credit and loan | |
| | payments | |
| Economic | Analyzes adaptability to | Medium |
| Resilience Score | financial stress and external | |
| | economic conditions | |

In some embodiments, secondary financial indicators provide additional context for financial intervention effectiveness. The following Table 21 lists some example secondary financial indicators (also referred to as secondary features) that may be considered by the PBI unit 212.

TABLE 21

| | | Importance |
|---|---|---|
| Feature | Description | Weight |
| Macroeconomic | Adjusts scoring dynamically | Medium |
| Sensitivity Factor | based on market trends | |
| Spending Pattern | Detects unusual financial | Medium |
| Deviation | behavior that could | |
| | indicate financial distress | |
| Debt | Evaluates historical progress | Low |
| Payoff Trajectory | in paying off loans and | |
| | credit card balances | |
| Nudging | Measures user responsiveness | Low |
| Engagement | to AI-driven financial | |
| Score | interventions | |

In some embodiments, by prioritizing long-term financial behavior optimization over short-term financial transactions, the PBI unit 212 may ensure that users develop sustainable financial habits that lead to lasting financial well-being.

In some embodiments, to validate the PBI unit's predictive accuracy and real-world effectiveness before deployment, the PBI model may be tested against the traditional financial advisory models. The following Table 22 lists testing results of a test using a dataset of over 1 million anonymized financial records.

TABLE 22

| | | Traditional |
|---|---|---|
| | | Financial |
| Metric | PBI | Advisory Models |
| Accuracy | 0.92 | 0.79 |
| (AUC-ROC) | | |
| Increase in | 28% | 10% |
| Savings Rate | improvement | improvement |
| Reduction in | 40% | 15% |
| Late Payments | decrease | decrease |

From the table, it can be seen that key performance findings include that the PBI unit 212 improved savings rates by 28%, significantly outperforming traditional financial guidance models. In addition, the PBI users experienced a 40% reduction in late payments, attributed to AI-powered financial nudging strategies. Further, PBI users engaged 3× more frequently with AI-driven financial interventions, leading to higher financial awareness and improved decision-making.

Overall, the PBI unit 212 represents a major advancement in financial behavior optimization, shifting from static financial advisory approaches to real-time AI-driven financial interventions. By integrating reinforcement learning, behavioral finance analytics, and macroeconomic modeling, the PBI unit 212 may provide a dynamic, data-driven approach to improving financial wellness.

In some embodiments, to further refine financial behavior modeling, federated learning AI may be expanded by the PBI unit 212 to enable cross-institutional financial intervention strategies while maintaining privacy compliance. In addition, reinforcement learning models may be refined to enhance personalized financial guidance and AI-driven decision-making. Further, macroeconomic impact sensitivity may be enhanced to better tailor nudging interventions based on financial market conditions. By leveraging AI-powered behavioral analytics, real-time financial interventions, and adaptive financial guidance, the PBI unit 212 may ensure that individuals and financial institutions have the tools needed to promote long-term financial well-being.

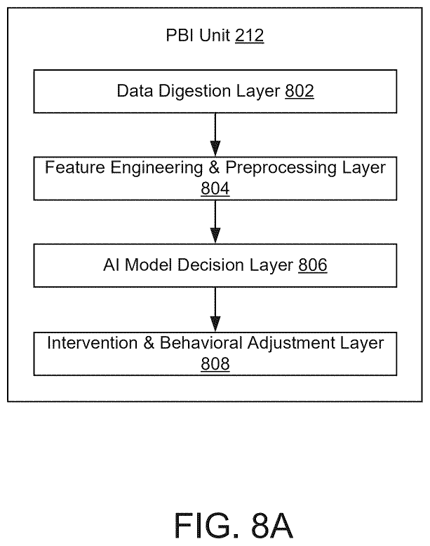

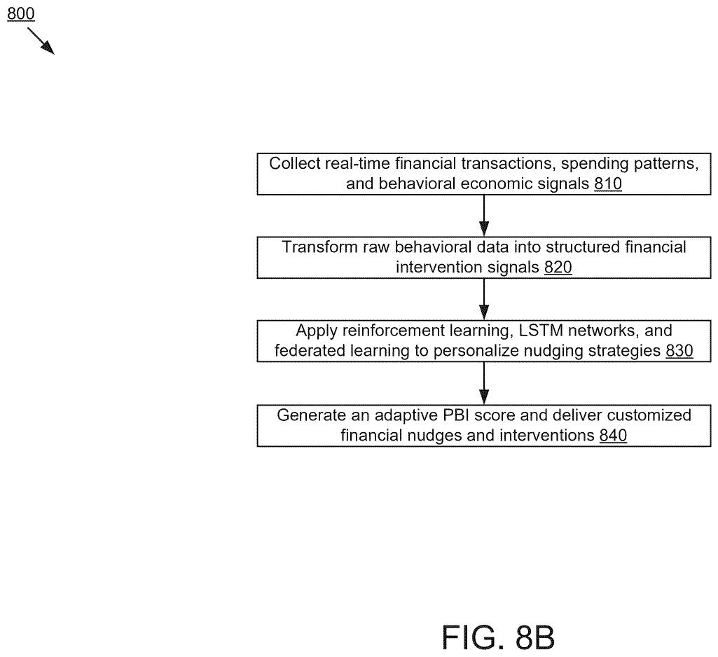

In the following, the AI decision-making process behind the PBI model is further described with reference to a system architecture of the PBI unit 212 shown in FIG. 8A.

As described earlier, the PBI unit 212 is an advanced AI-driven behavioral finance framework configured to optimize financial decision-making, spending habits, and long-term financial well-being. Unlike static financial advisory models, which offer generalized financial recommendations, the PBI unit 212 may deliver personalized, real-time AI-driven nudges and financial interventions that dynamically adapt to user behavior, financial goals, and economic conditions. In some embodiments, by integrating reinforcement learning, LSTM-based financial behavior modeling, and federated learning, the PBI unit 212 may enable secure, data-driven behavioral adjustments that help users develop positive financial habits.

In some embodiments, the PBI AI framework is structured into four key decision layers, each responsible for ingesting, processing, and optimizing financial behavior signals.

The first layer is a data ingestion layer 802, which is configured to collect real-time financial transactions, spending patterns, and behavioral economic signals to ensure that AI-driven nudging remains personalized and context-aware.

The second layer is a feature engineering & preprocessing layer 804, which is configured to transform raw financial behavior data into structured intelligence metrics such as the behavioral spending index (BSI), savings habit recognition (SHR), and credit utilization trends (CUT). These indicators may allow AI models in the PBI unit 212 to detect financial decision patterns and risk behaviors.

The third layer is an AI model decision layer 806, which is configured to leverage reinforcement learning for behavioral intervention timing, LSTM networks for financial behavior forecasting, and federated learning for privacy-preserving AI-driven financial analytics. These various AI models may work together to optimize nudging strategies, predict spending behaviors, and ensure adaptive AI-driven interventions.

The fourth layer is an intervention & behavioral adjustment layer 808, which is configured to generate a PBI score and deliver real-time AI-driven nudges, personalized financial alerts, and predictive savings guidance. This may ensure that users receive dynamic, data-driven financial interventions tailored to their financial needs.

FIG. 8B is a flowchart illustrating an example method 800 for processing financial data through an AI-driven decision pipeline of the PBI unit, according to some embodiments. The automated AI decision pipeline may ensure that the PBI unit 212 continuously learns, adapts, and delivers proactive financial nudging insights that encourage users to make informed financial decisions.

### Step 810: Collect Real-Time Financial Transactions, Spending Patterns, and Behavioral Economic Signals.

The first step in the PBI pipeline is real-time data ingestion, where financial transactions, budget adherence, and spending behaviors are collected and analyzed to detect patterns in financial decision-making. Example source data may include but are not limited to live financial transactions (e.g., debit/credit activity, subscriptions, bill payments), budgeting and savings patterns (e.g., adherence to financial goals, emergency fund utilization), debt repayment history (e.g., credit card balances, loan installments, on-time vs. late payments), etc. In some embodiments, to ensure high-quality behavioral insights, the PBI unit 212 may apply financial trend normalization, pattern detection, and AI-driven clustering before further processing.

Step 820: Transform Raw Behavioral Data into Structured Financial Intervention Signals.

In some embodiments, once financial behavior data is ingested, the PBI unit may extract key features that allow AI models to personalize nudging interventions and optimize financial decision strategies. Example key features extracted for the PBI score calculation may include but are not limited to BSI that measures consistency and deviations in spending habits, SHR that identifies whether users maintain predictable savings behaviors, CUT that monitors short-term vs. long-term credit dependency and assesses financial risk levels, etc. In some embodiments, by analyzing these behavioral finance indicators, the PBI unit 212 may ensure that AI-driven nudging is personalized, actionable, and aligned with a user's financial health.

### Step 830: Apply Reinforcement Learning, LSTM Networks, and Federated Learning to Personalize Nudging Strategies.

In some embodiments, the PBI intelligence engine is built on a multi-model AI decision layer, integrating advanced deep learning models to optimize nudging effectiveness. The following Table 23 lists example AI models included therein.

TABLE 23

| Model Type | Purpose | Decision Factor |
|---|---|---|
| Reinforcement | Optimize AI-driven | Adjusts intervention |
| Learning | nudging strategies | timing & message |
| | | type dynamically |
| LSTM | Predict financial | Identifies user-specific |
| Networks | behavior trends | spending risks and |
| | | intervention windows |
| Federated | Secure AI-powered | Trains intervention models |
| Learning | financial behavior | across institutions without |
| | analytics | exposing raw data |

In some embodiments, these AI models may work collaboratively to ensure that the PBI unit 212 delivers high-precision financial nudging insights while maintaining user privacy and security.

### Step 840: Generate an Adaptive PBI Score and Deliver Customized Financial Nudges and Interventions.

In some embodiments, once the AI models process financial behavior data, the PBI unit 212 may generate real-time financial nudges and personalized intervention strategies. In some embodiments, the final PBI score calculation may be continuously adjusted based on financial habits, savings trends, and intervention engagement metrics. In addition, real-time AI-driven nudges that guide users toward optimal financial decision-making may be generated. Further, AI-driven behavioral reinforcement strategies may be adapted to enhance long-term financial resilience. This can ensure that users actively engage with AI-driven financial nudges, leading to improved savings, reduced debt dependency, and enhanced financial well-being.

Overall, the PBI AI framework represents a significant advancement in financial behavior optimization, integrating deep learning, reinforcement learning, and federated learning to create a dynamic, AI-driven financial wellness system. Unlike traditional financial advisory approaches, which focus on static recommendations, the PBI unit 212 may offer real-time, adaptive financial nudging strategies that continuously improve user financial decision-making.

In some embodiments, to further refine financial behavior modeling, LSTM-based predictive financial behavior insights may be expanded to enhance long-term financial guidance. In addition, reinforcement learning algorithms may be refined to increase user engagement and effectiveness of financial interventions. Further, federated learning models may be enhanced to enable cross-institutional AI-driven financial well-being assessments. By leveraging AI-powered behavioral finance analytics, real-time nudging strategies, and privacy-preserving AI techniques, the PBI unit 212 may ensure that financial institutions and consumers benefit from an adaptive, data-driven financial wellness platform.

### Data Flow & Feature Engineering for Financial Intelligence AI

From the above descriptions, it can be seen that the data flow & feature engineering framework is one of the key parts of the AI-driven risk assessment system 100. The framework is configured to ensure accurate, real-time financial risk assessments by leveraging advanced data ingestion pipelines, feature transformation techniques, and AI-driven risk modeling. This section provides further details outlining the data collection process, preprocessing steps, feature selection strategies, and AI model inputs that power the risk assessment system's scalable, regulatory-compliant financial intelligence system.

In some embodiments, by integrating dynamic data transformation techniques, federated learning enhancements, and anomaly detection capabilities, the AI-driven risk assessment system 100 may ensure that financial institutions, policymakers, and fraud detection systems receive timely and precise financial insights. In addition, the framework may support credit risk modeling, fraud prevention, and economic stability monitoring, making it a foundational component of AI-driven financial intelligence.

In some embodiments, the AI-driven risk assessment system 100 may aggregate financial data from multiple high-integrity sources to create a comprehensive risk profile for individual users and financial institutions. The transactional data pipeline may include but are not limited to bank transactions, credit card spending, and recurring payments, capturing real-time financial behaviors. Additionally, the system 100 may collect credit and loan data, tracking loan repayment histories and credit utilization trends to assess financial responsibility.

In some embodiments, beyond transactional records, behavioral finance metrics may also play a crucial role in AI risk assessments. The system 100 may continuously monitor spending frequency, income fluctuations, and savings contributions to evaluate an individual's financial resilience. Furthermore, economic and regulatory data, including macroeconomic indicators and open banking APIs, may ensure that risk assessments remain aligned with market trends and evolving financial regulations.

In some embodiments, the data processing pipeline may transform raw financial data into structured AI model inputs through certain secure, multi-stage processing workflows. For example, in the first step of data collection and secure transfer that involve aggregating data from open banking APIs, financial institutions, and proprietary sources, AWS® technologies and the like technologies, including AWS® Kinesis and S3®, may facilitate both real-time streaming and batch data storage, ensuring scalability and security.

In some embodiments, once the data is collected, data cleaning and preprocessing steps may be further applied to normalize transaction types, handle missing values, and tokenize sensitive financial information. These processes may ensure compliance with GDPR and CCPA privacy regulations, preventing raw financial data from being exposed during AI processing.

In some embodiments, the feature engineering and selection stage may extract key behavioral finance metrics, such as spending patterns and financial distress indicators. In some embodiments, the system may apply time-weighted risk adjustment, which may prioritize recent financial transactions over historical data, ensuring that AI models remain adaptive to real-time financial behaviors, as described earlier.

In the final stage, AI model feature transformation, processed financial data may be converted into structured machine learning inputs. These features are then distributed across multiple AI models, including LSTM networks for sequential financial forecasting, XGBoost for risk classification, and reinforcement learning for personalized financial interventions, as described earlier.

In some embodiments, the system's risk assessment models may rely on a set of high-impact financial features that help predict credit risk, financial distress, and economic resilience. For example, the spending volatility feature may measure fluctuations in daily and monthly expenditures, helping identify unstable financial behaviors. The income stability feature may track earnings consistency and employment patterns, ensuring that AI models can distinguish between stable vs. high-risk financial profiles. The credit utilization ratio feature may evaluate an individual's dependency on credit, allowing financial institutions to assess risk exposure. Meanwhile, the emergency savings health feature may monitor liquidity reserves, ensuring that risk assessments account for financial preparedness, as described earlier. In some embodiments, recurring financial difficulties may be captured through the recurring financial setbacks feature, which flags frequent overdrafts, missed payments, and economic stress events. Additionally, the loan repayment timeliness feature may track an individual's history of on-time vs. late payments, ensuring that creditworthiness assessments remain accurate and behavior driven. In some embodiments, various other features described above may be also captured through the feature engineering, which is not repeated herein.

The following Table 24 lists some example features and their applications in specific models described above.

TABLE 24

| | | Used |
|---|---|---|
| Feature Name | Description | In Model |
| Spending Volatility | Measures fluctuations in | MFS, RAFI |
| | daily & monthly spending | |
| Income Stability | Tracks consistency of | MFS, RAFI |
| | earnings & employment | |
| Credit | Evaluates dependency | RAFI, Stress |
| Utilization Ratio | on credit | Detection |
| Emergency | Monitors availability of | MFS, RAFI |
| Savings Health | liquidity reserves | |
| Recurring | Captures frequent financial | Financial Stress |
| Financial Setbacks | distress patterns | Detection |
| Loan Repayment | Tracks history of on-time | MFS, RAFI |
| Timeliness | & late payments | |

In some embodiments, to maintain real time financial intelligence, the AI-driven risk assessment system disclosed herein may employ dynamic feature weighting and adjustment mechanisms. For example, the AI models may continuously update financial risk assessments by adjusting feature importance based on real-time spending and savings behaviors.

In some embodiments, through anomaly detection integration, the AI-driven risk assessment system 100 may flag unexpected spending surges, unusual cash withdrawals, and inconsistent income patterns that may indicate financial distress or fraud risks. Additionally, the AI-driven risk assessment system's federated learning AI enhancements may ensure that AI models receive continuous updates from multiple financial institutions, allowing for cross-institutional financial intelligence sharing without compromising user privacy.

In some embodiments, the AI-driven risk assessment system's feature engineering pipeline may be widely applied in banking and credit risk modeling. The system may provide real-time credit scoring alternatives that leverage behavioral finance metrics rather than traditional credit scores. This allows financial institutions to identify high-risk borrowers based on spending volatility, income stability, and financial adaptability, leading to more precise lending decisions and risk mitigation strategies.

In some embodiments, the AI-driven feature engineering techniques may significantly enhance fraud detection and anomaly identification. By analyzing spending behaviors, transaction anomalies, and financial distress signals, the system may detect fraudulent transactions in real time. Additionally, anomaly detection algorithms may continuously monitor user spending trends, allowing financial institutions to intervene in suspicious financial activities before fraud escalates.

Beyond banking, the AI-driven risk assessment system's data intelligence framework may support macroeconomic and public policy applications. Governments and financial regulators may use the system to monitor economic stability in real time, leveraging AI-driven financial intelligence for crisis forecasting and policy decision-making. Furthermore, AI-generated insights may help policymakers improve financial inclusion strategies, ensuring that underserved populations receive better access to financial services and credit opportunities.

The data flow & feature engineering pipeline is the foundation of the disclosed AI-driven financial intelligence platform, ensuring accurate, real-time financial risk assessments. By integrating secure data ingestion, dynamic feature transformations, and AI-powered financial behavior analysis, the AI-driven risk assessment system 100 may deliver scalable, regulatory-compliant risk insights that drive improved financial decision-making, fraud prevention, and economic stability tracking.

As financial AI governance evolves, the AI-driven risk assessment system 100 may continue to enhance its data flow architecture and feature engineering strategies. For example, federated learning AI capabilities may be expanded, enabling cross-institutional risk model collaboration while preserving user privacy. Additionally, new anomaly detection techniques may be integrated to improve fraud identification accuracy and financial risk monitoring.

### Additional Components in the System

### Security & Compliance Framework for AI in Finance

In some embodiments, the disclosed AI-driven risk assessment system 100 is configured to include a security & compliance framework ensuring that AI-driven financial intelligence adheres to global financial regulations, including but are not limited to GDPR, CCPA, open banking, and ISO 27001. This framework establishes a structured approach to data privacy, security protocols, and AI model transparency, ensuring that financial institutions and users benefit from an ethical, compliant, and secure AI environment.

By incorporating advanced encryption mechanisms, federated learning privacy safeguards, and AI model governance policies, the AI-driven risk assessment system may ensure that financial institutions can utilize AI-driven insights while maintaining compliance with evolving regulatory requirements. Additionally, this framework may provide a foundation for auditable AI decision-making, fraud prevention, and risk mitigation, ensuring that AI-driven financial analysis remains trustworthy, transparent, and legally compliant.

In some embodiments, the AI-driven risk assessment system 100 is configured to align with major regulatory frameworks to protect consumer financial data, AI decision-making processes, and institutional risk assessments.

Under the GDPR, the AI-driven risk assessment system 100 may implement data minimization principles, ensuring that only essential financial data is processed for AI-driven insights. The system may also support the Right-to-Be-Forgotten, allowing users to request the removal of AI-generated financial assessments from the system. To safeguard sensitive data, AI model training data may be encrypted both at rest and in transit, ensuring that financial institutions comply with strict European privacy laws.

For compliance with the CCPA, the AI-driven risk assessment system 100 may provide users with the ability to opt out of AI based financial decision-making. This ensures that individuals can have full control over how their financial behaviors are analyzed and scored. Additionally, financial institutions utilizing the AI-driven risk assessment system 100 are expected to grant users access to their AI-generated financial risk scores and behavioral assessments, ensuring data transparency and portability in accordance with CCPA requirements.

The framework may also ensure adherence to open banking compliance by integrating secure API access under strict authentication and data-sharing protocols. This then allows financial institutions to leverage AI-powered financial intelligence while maintaining consumer data privacy. Federated learning techniques ensure that AI model improvements do not require institutions to expose raw financial data, thus minimizing third-party risk. Every AI-driven financial risk assessment is logged and auditable, allowing regulators to review AI-generated decisions for transparency and compliance verification.

In some embodiments, to ensure the highest level of data security and financial privacy, the AI-driven risk assessment system 100 may incorporate end-to-end encryption (e.g., using AES-256 encryption) for all stored and transmitted financial data. The platform may also employ tokenization techniques, where sensitive financial attributes are replaced with encrypted tokens before AI processing occurs. This ensures that personally identifiable financial data remains protected, even when being analyzed by AI models.

In some embodiments, the federated learning AI privacy protections may allow financial institutions to train AI models collaboratively without sharing raw customer data, as described earlier. This approach ensures that cross-institutional AI-driven insights can be developed without exposing sensitive financial information, maintaining compliance with global data protection regulations.

In some embodiments, to maintain transparency and fairness in AI-driven financial intelligence, the AI-driven risk assessment system 100 may regularly conduct bias detection and fairness audits on its AI models. These audits may ensure that algorithmic biases are identified and mitigated, reducing the risk of discriminatory financial decision-making. In some embodiments, the platform may also integrate explainable AI (XAI) methodologies, allowing financial institutions and regulators to understand the reasoning behind AI-driven financial risk scores and recommendations.

In some embodiments, for enhanced accountability, the AI-driven risk assessment system 100 may maintain regulatory audit logs of all AI decisions and financial risk classifications. This historical record may allow for compliance audits, regulatory verification, and AI governance oversight, ensuring that financial institutions can demonstrate transparency in their AI-driven decision processes.

In some embodiments, to protect financial data and AI processing infrastructure, the AI-driven risk assessment system 100 may leverage AWS® or other similar security frameworks, ensuring that AI-driven financial intelligence operates in a highly secure, cloud-optimized environment. For example, access to AI training and inference endpoints may be managed through AWS® IAM role-based access control (RBAC), restricting data access to authorized personnel only.

In some embodiments, to mitigate cyber threats, AWS® Shield & distributed denial-of-service (DDoS) protection or other similar strategies may be implemented, providing continuous monitoring and defense against DDoS attacks. Furthermore, AWS® Nitro Enclaves or other similar functions may be utilized to create hardware-enforced secure environments for AI model training, ensuring that sensitive financial data remains isolated and protected from unauthorized access.

In some embodiments, the AI-driven risk assessment system 100 may be configured to align with SOC 2 Type II certification standards, ensuring best practices for data security, confidentiality, and availability. Additionally, the platform may feature automated compliance reporting, allowing financial institutions to generate real-time regulatory reports for audit and verification purposes.

In some embodiments, to enhance financial security monitoring, the AI-driven risk assessment system 100 may employ AI-powered security analytics to detect real-time transaction risks and financial fraud patterns. For example, by continuously scanning for anomalies and suspicious activities, the system 100 may provide proactive risk mitigation strategies, strengthening the overall security framework.

### Incident Response & Risk Mitigation

In some embodiments, to ensure uninterrupted financial risk assessments, the AI-driven risk assessment system 100 may incorporate failover redundancy mechanisms that automatically switch to human review processes if an AI risk-model encounters failures. Additionally, the system 100 may implement automated risk adjustments, dynamically modifying financial risk thresholds when AI models detect anomalies, ensuring that financial institutions maintain accurate and stable risk assessments.

In some embodiments, the AI-driven risk assessment system 100 may integrate behavior-based anomaly detection to identify fraudulent transactions in real time. By leveraging AI-driven financial monitoring, the system 100 may detect suspicious financial behaviors, allowing for proactive fraud intervention. In some embodiments, the AI models included therein may undergo continuous retraining against emerging fraud patterns and adversarial attack scenarios, ensuring that the AI-driven risk assessment system 100 remains resilient to evolving financial threats.

Overall, the security & compliance framework for the AI-driven risk assessment system 100 may establish a comprehensive, regulation-compliant security infrastructure that ensures AI-driven financial intelligence operates within the highest ethical, security, and compliance standards. By integrating end-to-end encryption, federated learning privacy protections, and continuous regulatory audits, the AI-driven risk assessment system 100 may maintain compliance with GDPR, CCPA, open banking, and financial security best practices.

In some embodiments, the framework may further expand its automated audit mechanisms, enabling real-time compliance monitoring of AI-driven financial decision logs. Additionally, the system may enhance multi-institutional compliance verification for open banking, ensuring that AI-driven financial intelligence adheres to global financial data-sharing laws. Lastly, the AI-driven risk assessment system 100 may extend its global compliance monitoring efforts, adapting to evolving AI governance laws and financial security standards.

### Example Applications of AI-Driven Risk Assessment Models

The AI-driven risk assessment system 100 is designed to be a transformative force across multiple industries by integrating behavioral finance, machine learning, and predictive analytics into financial risk assessment and decision-making. Unlike traditional models that rely solely on historical financial data, the AI models in the various units described above (also referred to as AI-driven risk assessment models) may introduce dynamic, real-time insights that ensure greater adaptability across various sectors.

Through the use of MFS, RAFI, FSSD, and AI-powered financial nudging, the system 100 may provide highly personalized, adaptive risk assessments that optimize financial decision-making across insurance, healthcare, banking, fintech, and public policy sectors.

### Banking & Financial Services

The banking and financial services industry depends on accurate risk modeling, fraud detection, and real-time credit decisioning to ensure stability and growth. Traditional credit models often fail to capture real-time financial behavior, leading to misclassified risk profiles and suboptimal lending decisions. The various AI models in the disclosed system 100 may integrate behavioral finance analytics, federated learning, and AI-powered predictive modeling to enhance credit risk assessment, fraud prevention, and borrower financial well-being.

The disclosed AI models may employ several advanced AI-driven financial intelligence tools to improve banking services. The MFS model may enable behavior-based credit risk assessment, providing an alternative to traditional FICO® scores by analyzing real-time spending, income patterns, and liquidity management. The RAFI model may rank borrower resilience, helping financial institutions assess long-term repayment capability beyond static credit history.

To mitigate risk, the FSSD model may identify early warning signs of loan defaults, predicting financial distress 4-6 months before traditional models. Additionally, federated learning AI may enhance fraud detection across institutions, allowing banks to collaboratively train AI models without sharing raw customer data, ensuring both privacy and compliance with data protection regulations. Lastly, AI-powered financial nudging may improve borrower financial behavior by providing real-time, personalized financial guidance to encourage responsible credit usage and savings habits.

In one example application, behavior-based credit scoring is revolutionized through the integration of MFS and RAFI, allowing banks to assess borrower creditworthiness beyond traditional credit scores. By analyzing real-time financial transactions, discretionary spending trends, and economic adaptability, the disclosed system 100 may provide a more accurate and inclusive credit scoring system, benefiting thin-credit and underbanked individuals.

In another example application, loan default prediction may be significantly enhanced through AI-driven early detection models. For example, the disclosed AI models' predictive analytics may identify financial distress 4-6 months earlier than conventional models, allowing banks to proactively intervene with loan restructuring or alternative repayment options, reducing delinquency rates and financial losses.

In another example application, fraud detection & anomaly identification may be improved through AI-powered behavioral analysis, which may continuously monitor transaction patterns, spending behaviors, and financial anomalies. The system may flag high-risk transactions, detect fraudulent activities in real time, and prevent financial crimes before they occur. In some embodiments, by leveraging federated learning AI, financial institutions may share fraud detection insights across networks without compromising customer privacy.

In another example application, automated credit decisioning may ensure real-time, AI-driven loan approvals, particularly for thin-credit borrowers and digital lending platforms. By integrating behavioral risk analysis, spending adaptability, and real-time income stability metrics, the disclosed system may enable banks to make faster, more accurate lending decisions, expanding access to credit while minimizing risk exposure.

By leveraging advanced AI modeling, predictive analytics, and behavioral finance insights, the disclosed system may enable banks and financial institutions to optimize risk assessment, fraud prevention, and credit decisioning, ultimately leading to better financial outcomes for both lenders and borrowers.

### Insurance

The insurance industry faces challenges in accurately pricing risk, detecting fraudulent claims, and improving policyholder financial stability. Traditional risk models rely heavily on historical claims data and generalized actuarial calculations, which fail to capture real-time financial resilience and behavioral risk patterns. The disclosed system may integrate behavioral finance analytics, predictive AI modeling, and federated learning techniques to enhance risk assessment, optimize premium pricing, and improve policyholder retention.

The RAFI scoring may serve as a key metric for tracking policyholder financial resilience. By analyzing income stability, spending adaptability, and emergency fund availability, the RAFI model may provide insurers with a real-time risk assessment, enabling them to adjust coverage and pricing dynamically.

The FSSD model may be used to identify early claim risks, flagging potential fraudulent, high-risk, or exaggerated claims before payouts occur. By continuously monitoring financial distress indicators and behavioral anomalies, insurers may reduce false claims, excessive payouts, and long-term financial losses.

To provide macro-level industry insights, the MI model may enable insurers to monitor systemic risk trends, allowing for early intervention strategies and policy adjustments. By leveraging economic indicators and consumer financial patterns, the MI model may help insurers anticipate shifts in claim behaviors and industry-wide risk fluctuations.

Additionally, the AI-powered financial nudging may play a vital role in policyholder retention and financial resilience modeling. By providing real-time financial guidance, savings recommendations, and debt management strategies, AI nudging may help policyholders improve financial discipline, reducing policy lapses, missed payments, and unnecessary claims.

In one example application, risk based premium pricing may be enhanced through real-time behavioral finance insights, allowing insurers to dynamically adjust insurance premiums based on financial resilience. Instead of relying solely on historical risk assessments, insurers may factor in ongoing financial behaviors, spending stability, and liquidity risk, ensuring that policyholders receive personalized pricing aligned with their actual financial condition.

In another example application, early claim risk identification may be significantly improved through FSSD, which identifies high-risk policyholders before claims are filed. By monitoring anomalous financial activities, sudden liquidity crises, or behavioral red flags, insurers may proactively investigate potential fraud, assess claim legitimacy, and optimize payout decisions.

In another example application, policyholder retention & financial resilience modeling may allow insurers to track customer financial behavior over time, predicting which policyholders are at risk of defaulting on payments or lapsing coverage. AI-powered financial resilience modeling may enable insurers to offer personalized financial interventions, such as customized payment plans, financial wellness programs, or premium restructuring, to retain customers and prevent policy churn.

By leveraging AI-driven behavioral insights, predictive modeling, and financial resilience tracking, the disclosed system may enhance risk assessment, reduce fraudulent claims, and ensure dynamic, fair premium pricing. These capabilities position insurers to better manage risks, improve profitability, and foster long-term customer relationships.

### Public Policy & Government

Governments and policymakers rely on accurate financial intelligence to design effective economic policies, optimize financial aid distribution, and ensure regulatory compliance. Traditional economic monitoring methods often rely on historical data and broad economic indicators, making it difficult to detect financial distress in real time or provide targeted financial interventions. The disclosed system integrates AI-driven financial modeling, behavioral finance analytics, and privacy-preserving federated learning to offer real-time financial stress detection, economic forecasting, and regulatory oversight.

The MI model may play a critical role in economic stability forecasting, allowing governments to track financial resilience at both individual and population levels. By analyzing macroeconomic trends, employment fluctuations, and household financial behaviors, the MI model may enable policymakers to anticipate financial crises, optimize fiscal policies, and prevent economic downturns.

The FSSD model may provide early warning signs of financial distress, allowing governments to proactively implement economic relief programs before crises escalate. By continuously analyzing household spending patterns, liquidity constraints, and rising financial vulnerabilities, this AI-powered system may help in predicting economic slowdowns, unemployment spikes, and systemic financial risks.

To ensure data privacy and security, the federated learning AI may allow governments to analyze financial behavior across populations without centralizing or exposing sensitive personal data. This enables multi-agency collaboration while maintaining compliance with global data protection laws such as GDPR and CCPA.

Additionally, the AI-powered financial nudging may help governments optimize financial aid distribution, ensuring that resources reach those most in need. By assessing real-time financial health metrics, AI-driven nudging may provide targeted financial assistance, suggest debt management strategies, and encourage savings behaviors to reduce long-term economic dependency.

In one example application, economic stability forecasting may be enhanced through MI scoring, which enables governments to monitor financial stress indicators across populations. By analyzing income fluctuations, household debt levels, and macroeconomic trends, the MI model may help policymakers anticipate financial instability and implement preventive economic measures to ensure long-term economic resilience.

In another example application, financial aid optimization may leverage AI-driven financial health analysis to ensure that government assistance programs are distributed efficiently. Instead of using static demographic criteria, the disclosed system may dynamically assess financial vulnerability in real time, allowing governments to allocate resources where they are needed most while reducing waste and fraud in aid programs.

In another example application, regulatory compliance & AI transparency plays a crucial role in ensuring fairness in AI-driven financial decision-making. The disclosed system may help regulators monitor AI ethics in lending, banking, and financial risk assessments, ensuring that AI models remain explainable, unbiased, and compliant with global financial regulations. This capability supports better governance, consumer protection, and ethical AI implementation in financial services.

By leveraging AI-powered financial intelligence, real-time economic risk monitoring, and privacy-preserving analytics, the disclosed system may empower governments and policymakers to enhance economic resilience, improve financial inclusion, and ensure regulatory transparency.

### FinTech & Digital Payments

The FinTech and digital payments industry thrives on real-time financial decision-making, instant credit approvals, and fraud prevention. Traditional risk assessment models rely heavily on historical credit data, which often fails to capture real-time borrower behavior, spending adaptability, and fraud risk patterns. The disclosed system may leverage AI-driven behavioral finance modeling, real-time credit risk scoring, and federated fraud detection to enhance digital lending, payment security, and financial wellness solutions.

The MFS scoring may power real-time credit risk assessments, providing FinTech lenders with instant borrower risk profiling. Instead of relying solely on credit history, the MFS model may evaluate spending behaviors, liquidity patterns, and financial adaptability, making it ideal for alternative lending platforms, buy now pay later (BNPL) providers, and micro-loan issuers.

The FSSD model may be used to identify potential fraud risks and anomalies, ensuring real-time transaction security. By continuously monitoring spending deviations, high-risk transactions, and behavioral inconsistencies, this AI model may help FinTech firms prevent fraud before it escalates.

The AI-powered financial nudging may enhance automated savings, wealth management, and financial guidance, ensuring users receive personalized financial recommendations based on their spending patterns, income fluctuations, and savings goals. This then enables FinTech platforms to offer smarter financial products, encourage responsible spending, and optimize wealth-building strategies.

The federated learning AI may strengthen multi-platform fraud detection models, enabling FinTech firms to collaborate on AI-driven fraud intelligence without exposing sensitive customer data. This then ensures that risk detection models are continuously updated and refined across multiple institutions while maintaining compliance with global data privacy laws.

In one example application, fraud prevention & risk mitigation may be significantly improved through AI-powered financial behavior monitoring. By detecting high-risk transactions and inconsistencies in spending patterns, the disclosed system may help FinTech firms mitigate fraud risks in real time, reducing financial losses and improving transaction security.

In another example application, real-time credit risk scoring may enable digital lenders to assess borrower risk instantly. Instead of relying on traditional credit scores, the system's behavioral tracking capabilities may analyze spending consistency, income stability, and financial adaptability, allowing FinTech companies to approve or decline loans with greater accuracy while expanding credit access to underserved populations.

In another example application, automated wealth & savings management may be enhanced through AI-driven financial recommendations, helping users optimize savings contributions, investment allocations, and debt repayment strategies. The disclosed system may ensure that consumers receive personalized, data-driven financial guidance, enabling them to build long-term financial security through automated wealth-building strategies.

By integrating real-time AI-driven financial modeling, fraud detection, and personalized financial guidance, the disclosed system may empower FinTech firms to enhance security, optimize credit risk assessments, and improve financial outcomes for consumers.

### Healthcare & Medical Financing

The healthcare industry faces growing challenges related to medical debt, patient financial resilience, and hospital revenue cycle management. Rising healthcare costs and unpredictable medical emergencies often lead to financial distress for patients and payment risks for providers. Traditional financial models in healthcare focus primarily on static credit scores, which fail to capture real-time patient financial health. The disclosed system integrates AI-driven financial resilience modeling, real-time financial stress detection, and adaptive payment strategies to improve patient financial outcomes and hospital financial planning.

The RAFI model may be used to assess patient financial resilience before medical procedures, treatment plans, or healthcare financing approvals. By analyzing income stability, spending adaptability, and liquidity reserves, the RAFI model may enable hospitals and insurers to determine the best financing terms for each patient, reducing the risk of unpaid medical bills and financial distress.

The FSSD model may proactively identify patients at risk of medical debt. By continuously monitoring financial stress indicators, payment history trends, and emergency fund availability, this AI system may allow healthcare providers to intervene early with financial assistance programs, customized payment options, or preventive debt counseling.

The AI-powered financial nudging may help patients manage their medical expenses responsibly by offering personalized financial guidance. AI-driven nudging may encourage patients to plan ahead for medical costs, optimize insurance usage, and improve financial habits, reducing the long-term burden of healthcare expenses.

The MI scoring may provide hospitals and healthcare institutions with real-time financial planning insights. By aggregating economic indicators, patient payment trends, and industry-wide financial risks, the MI model may enable data-driven decision-making for hospital revenue optimization, risk mitigation, and financial stability management.

In one example application, predicting medical debt risk is enhanced through AI-driven financial resilience assessments. By analyzing patient financial health before medical procedures, the disclosed system may help hospitals and insurers proactively prevent medical debt accumulation, allowing for better financial planning and risk mitigation strategies.

In another example, personalized payment plans may be optimized using RAFI scoring, which enables hospitals and healthcare financing providers to adjust repayment terms based on real-time patient financial resilience. Instead of one-size-fits-all financing, patients receive customized payment plans tailored to their ability to pay, reducing delinquency rates and improving hospital cash flow.

In another example application, healthcare financial nudging may provide patients with AI-driven financial guidance, helping them manage medical expenses more effectively. Through personalized reminders, automated financial suggestions, and predictive payment strategies, AI-powered nudging may help patients avoid late payments, improve budgeting for healthcare, and minimize financial stress related to medical bills.

By integrating behavioral finance analytics, AI-driven financial resilience modeling, and predictive risk assessment, the disclosed system may enhance financial decision-making for both patients and healthcare providers, ensuring better financial outcomes and improved access to healthcare services.

### Real Estate & Mortgage Lending

The real estate and mortgage lending industry requires accurate risk assessment models to evaluate homebuyers, predict mortgage defaults, and prevent foreclosures. Traditional mortgage approval processes rely heavily on credit scores and income history, which often fail to capture real-time financial behavior and resilience. The disclosed system may integrate AI-driven behavioral finance modeling, financial stress detection, and adaptive mortgage structuring to enhance risk evaluation, foreclosure prevention, and dynamic lending strategies.

The MFS model may enable alternative mortgage risk assessment, allowing lenders to evaluate potential homebuyers beyond traditional credit scores. By incorporating spending behavior, liquidity trends, and financial adaptability, the MFS scoring may provide a more comprehensive assessment of borrower stability, expanding homeownership opportunities to underserved populations.

The RAFI scoring may be used to predict mortgage default risks, ensuring that lenders can identify high-risk borrowers before financial distress escalates. By analyzing borrower resilience, emergency savings health, and spending patterns, the RAFI model may help mortgage providers refine lending terms and mitigate long-term risks.

The FSSD model may enhance early foreclosure identification by recognizing financial distress indicators before missed payments occur. By tracking income fluctuations, credit utilization trends, and liquidity constraints, this AI model may allow lenders to offer proactive financial solutions, such as loan modifications or restructuring options, to prevent defaults.

The federated learning AI may ensure that mortgage risk modeling remains privacy-compliant, enabling financial institutions to collaborate on risk assessment improvements without sharing raw customer data. This then enhances cross-institutional risk intelligence while maintaining data security and compliance with global regulations.

In one example application, alternative mortgage risk assessment may be made possible through behavioral finance-based risk modeling, which allows lenders to evaluate potential homebuyers beyond traditional credit scores. By analyzing real-time financial behaviors, the disclosed system may provide a more inclusive and dynamic mortgage approval process, ensuring that borrowers with strong financial habits but limited credit history can access home financing.

In another example application, predicting mortgage default risks may be significantly improved using the FSSD scoring, which provides early warnings of foreclosure risks. By identifying signs of financial distress months before missed payments occur, lenders may intervene with support measures such as adjusted payment plans, refinancing options, or targeted financial guidance to help borrowers avoid default and foreclosure.

In another example application, dynamic mortgage structuring may leverage real-time financial resilience data to adjust mortgage terms as a borrower's financial situation evolves. By integrating the RAFI scoring, mortgage lenders may offer flexible loan terms, interest rate adjustments, or payment deferrals, ensuring that mortgages remain sustainable and adaptable to changing economic conditions.

By applying AI-powered risk assessment, predictive financial distress modeling, and adaptive mortgage structuring, the disclosed system may help lenders improve loan performance, reduce foreclosure rates, and expand homeownership opportunities for a broader range of borrowers.

### Retail & Consumer Finance

The retail and consumer finance industry is rapidly evolving, with growing demand for BNPL services, personalized credit offerings, and in-house retail financing. Traditional credit assessment models often fail to capture real-time spending behaviors and financial adaptability, leading to misclassified risks and higher default rates. The disclosed system may integrate AI-powered risk assessment, financial stress detection, and personalized credit modeling to optimize retail lending, BNPL approvals, and customer financing strategies.

The MFS model may play a key role in BNPL risk evaluation, allowing retailers and consumer finance providers to assess applicants beyond traditional credit scores. By analyzing real-time spending patterns, liquidity trends, and financial adaptability, the MFS scoring may provide a more accurate and inclusive risk profile, ensuring responsible lending decisions.

The FSSD model may enhance retail credit monitoring by identifying high-risk consumer behaviors, including sudden income fluctuations, excessive credit utilization, and irregular spending patterns. This proactive risk detection may allow retailers and lenders to prevent defaults and optimize repayment plans.

The AI-powered financial nudging may enable personalized financial recommendations, helping consumers improve spending habits, manage debt effectively, and increase savings. By offering behavior-driven financial guidance, retailers may encourage responsible credit usage while enhancing customer loyalty and long-term financial health.

Federated learning AI may improve consumer credit modeling by allowing multiple retailers and financial institutions to collaboratively refine credit risk assessments without sharing sensitive consumer data. This privacy-preserving AI approach may ensure enhanced credit risk intelligence while maintaining compliance with global data protection regulations.

In one example application, BNPL risk analysis may be enhanced through real-time financial stability tracking, enabling BNPL providers to evaluate applicants based on behavioral finance trends rather than static credit history. This ensures that consumers who demonstrate responsible spending habits but lack traditional credit histories can access BNPL services responsibly while reducing default risks for retailers.

In another example application, personalized consumer credit modeling may leverage AI-driven risk assessment to tailor custom credit offers based on a consumer's financial behaviors. Instead of one-size-fits-all credit approvals, the disclosed system may enable dynamic credit limit adjustments, personalized financing terms, and better-targeted credit offers that align with each consumer's financial resilience.

In another example application, retail loan decisioning may be improved through AI-powered financial modeling, helping retailers determine which customers qualify for in-house financing options. By integrating spending history, income consistency, and real-time financial adaptability, the disclosed system may ensure that retailers can approve the right customers while minimizing financial risk exposure.

By integrating behavioral finance insights, AI-driven risk modeling, and real-time credit analysis, the disclosed system may help retailers and consumer finance providers optimize lending decisions, reduce credit risks, and enhance consumer financial well-being.

### Wealth Management & Investment Management

The wealth management and investment advisory industry is undergoing a transformation, with increasing demand for personalized investment strategies, AI-driven portfolio management, and real-time financial planning tools. Traditional wealth management models often rely on static financial data and risk tolerance questionnaires, which fail to capture dynamic financial behaviors and real-time risk exposure. The disclosed system may integrate AI-powered financial resilience modeling, behavioral finance analytics, and federated learning to optimize investment advisory, retirement planning, and portfolio management strategies.

The RAFI model may be a key component in investor risk profiling, allowing wealth managers to assess an individual's investment risk appetite dynamically. By analyzing financial resilience, spending adaptability, and liquidity reserves, the RAFI model may help create customized investment portfolios aligned with each investor's financial situation and risk tolerance.

The AI-powered financial nudging may enhance automated portfolio management, providing personalized investment recommendations based on real-time financial behavior and market trends. AI-driven nudging may ensure that investors make data-informed decisions, adjusting asset allocations dynamically to optimize returns while mitigating risk.

The MFS model may be used in retirement planning and financial security modeling, helping individuals strategically allocate savings for long-term financial stability. By analyzing income trends, savings behaviors, and spending patterns, the MFS model may enable financial advisors to provide proactive financial guidance for retirement optimization.

Federated learning AI may enhance AI-driven wealth management strategies, allowing financial institutions to collaborate on risk assessment improvements without compromising client data privacy. This ensures that investment strategies remain cutting-edge, adaptive, and compliant with global financial regulations.

In one example application, investor risk profiling may be improved through AI-driven financial behavior analysis, which assesses real-time financial stability and adaptability rather than relying solely on historical income or self-reported risk preferences. This may enable wealth managers to create more accurate, personalized investment portfolios that align with an investor's evolving financial resilience.

In another example application, automated portfolio management may be powered by AI-driven algorithms that continuously analyze financial markets and investor behaviors to optimize investment strategies. By using real-time data on financial resilience and market volatility, the disclosed system may ensure that investment portfolios are automatically rebalanced to maximize returns while minimizing risk.

In another example application, retirement planning & financial security modeling may be enhanced through MFS and RAFI models, which enable individuals to optimize their long-term savings strategies. By integrating behavioral finance insights and predictive economic modeling, AI-driven retirement planning tools may help users adjust their contributions, allocate assets strategically, and mitigate financial risks leading up to retirement.

By integrating AI-powered risk assessment, real-time investment optimization, and dynamic financial resilience modeling, the disclosed system may empower wealth managers, financial advisors, and individual investors to make smarter financial decisions and achieve long-term financial security.

The multi-industry applications of the disclosed system demonstrate its versatility and transformative impact across insurance, healthcare, banking, FinTech, and public policy. By integrating behavioral finance analytics, real-time AI decisioning, and predictive risk modeling, the system may enhance financial resilience, improve fraud detection, optimize credit risk assessment, and ensure regulatory compliance across diverse sectors.

As AI-driven financial intelligence continues to evolve, the disclosed system may remain at the forefront of innovation, providing scalable, privacy-preserving, and regulation-compliant solutions that enhance financial decision-making at both individual and institutional levels. Further advancements may be placed on expanding AI-driven financial modeling, enhancing cross-industry data integration, and developing new AI-driven financial wellness tools that empower users with real-time financial insights.

### AWS® Implementation

Besides the technical improvements described above, additional technical improvements of the disclosed AI-driven risk assessment system 100 may include but are not limited to increased inference speed, optimized federated learning, auto-scaling and cloud readiness, security enhancement, and reduced latency when implementing in an AWS® environment. For example, the disclosed AI-driven risk assessment system has been fully optimized for AWS® cloud infrastructure, leveraging advanced AI processing, federated learning, and enhanced security to deliver high-speed, scalable, and secure financial intelligence solutions. Compared to standard machine learning models, the system's AWS®-optimized architecture provides significant performance improvements in inference speed, federated learning optimization, scalability, security, and latency reduction.

For inference speed, traditional machine learning models rely on standard ML processing, which can be slow and computationally expensive. The AI models in the system have been optimized for AWS® GPU/CPU acceleration, significantly reducing inference times and improving model efficiency. This enhancement ensures that financial risk assessments, fraud detection, and behavioral finance analytics run in real time, improving decision-making speed for financial institutions and enterprises.

For federated learning optimization, while standard federated learning models enable privacy-preserving AI training, they often struggle with secure and efficient model updates. The disclosed system introduces enhanced encrypted updates with AWS® PrivateLink support, ensuring faster, more secure model synchronization across multiple financial institutions while maintaining data privacy and regulatory compliance.

For auto-scaling & cloud readiness, the standard machine learning models often have limited scalability, making them unsuitable for high-demand financial applications. The disclosed system is fully optimized for AWS® SageMaker®, EC2®, Lambda®, and Kubernetes®, enabling seamless auto-scaling, rapid deployment, and cloud-native AI processing. This ensures that financial institutions can scale AI-driven risk assessments and fraud detection systems efficiently.

For security enhancements, traditional ML security measures provide basic encryption, which may not meet the rigorous standards required for financial AI applications. The disclosed system incorporates AWS® Nitro Enclaves for secure data isolation, IAM® role-based security for access control, and end-to-end encryption to protect sensitive financial data, model updates, and transaction insights from unauthorized access or cyber threats.

For latency reduction, the standard ML models experience higher processing latency, limiting their ability to provide instant financial insights. The disclosed system leverages AWS® hardware acceleration, significantly reducing latency for AI-driven decision-making. This allows real-time fraud detection, instant credit risk assessments, and AI-powered financial recommendations to be executed without performance bottlenecks.

Overall, by leveraging AWS® cloud infrastructure, the disclosed system may achieve faster inference speeds, enhanced security, scalable federated learning, and reduced latency, making it the ideal AI-driven financial intelligence system for banking, insurance, FinTech, and public sector applications. This AWS®-optimized architecture ensures that financial institutions and enterprises can deploy real-time AI models with maximum efficiency, security, and scalability.

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

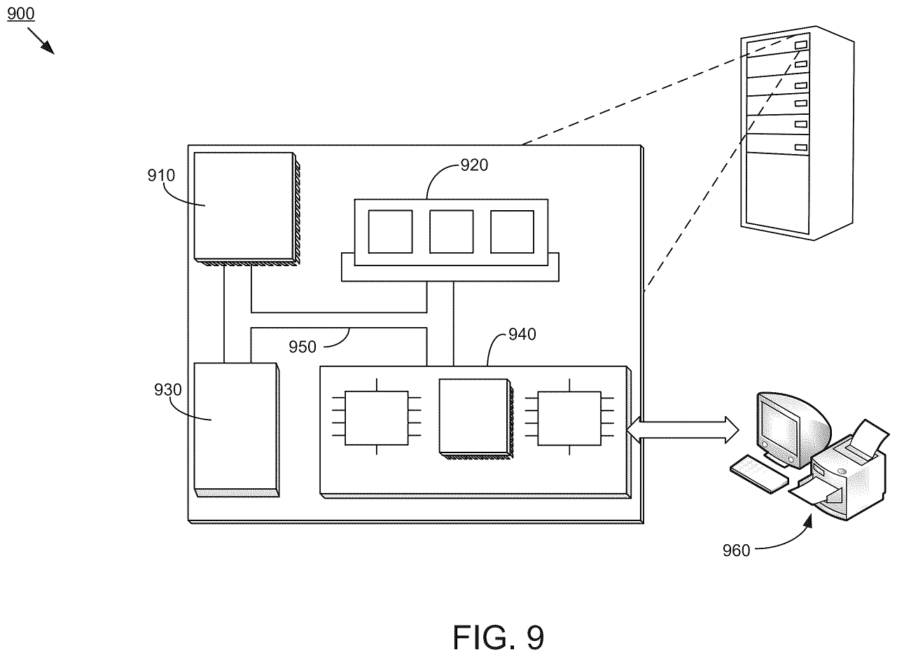

FIG. 9 is a block diagram of an example computer system 900 that may be used in implementing the technology described herein. General-purpose computers, network appliances, mobile devices, or other electronic systems may also include at least portions of the system 900. The system 900 includes a processor 910, a memory 920, a storage device 930, and an input/output device 940. Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-state drive, a flash drive, or some other large-capacity storage device. For example, the storage device may store long-term data (e.g., database data, file system data, etc.). The input/output device 940 provides input/output operations for the system 900. In some implementations, the input/output device 940 may include one or more network interface devices, e.g., an Ethernet card, a serial communication device, e.g., an RS-232 port, and/or a wireless interface device, e.g., a 902.11 card, a 3G wireless modem, or a 4G wireless modem. In some implementations, the input/output device may include driver devices configured to receive input data and send output data to other input/output devices, e.g., keyboard, printer, and display devices 960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 930 may be implemented in a distributed way over a network, such as a server farm or a set of widely distributed servers, or may be implemented in a single computing device.

Although an example processing system has been described in FIG. 9, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., a field programmable gate array (FPGA) or an application-specific integrated circuit (ASIC). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA or an ASIC.

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device (e.g., a universal serial bus (USB) flash drive), to name just a few.

Computer-readable media suitable for storing computer program instructions and data include all forms of non-volatile memory, media, and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of the client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A system, comprising:
a remote server having a processor and storage; and
a plurality of processing devices each having a second processor and a second storage,
wherein the remote server collects raw financial risk data through a processing device of a financial institution, where the financial institution does not share the raw financial risk data with other processing devices of the plurality of processing devices;
wherein a local AI model at the processing device of the financial institution is trained based on the raw financial risk data collected by the financial institution, to obtain a local AI model update;
wherein the processing device encrypts the local AI model update and transmits the encrypted local AI model update to the remote server having a remote central aggregator associated with a global AI model;
wherein the remote server receives other encrypted local AI model updates from the other processing devices, and trains the global AI model based on the encrypted local AI model update from the financial institution and the received other encrypted local AI model updates to generate a global AI model update;
wherein the processing device receives the global AI model update distributed to the processing device and update the locally trained AI model on the processing device based on the global AI model update; and
wherein the processing device detects a real-time high-risk transaction behavior of a customer of the financial institution using the locally updated AI model.

2. The system of claim 1, wherein the processing device evaluates the raw financial risk data to determine an individual's real-time financial behavior, and liquidity patterns to generate a microeconomics finance score for the individual using the locally updated AI model.

3. The system of claim 2, wherein the processing device adjusts the microeconomic finance score for the individual based on responses of the individual to a finance stress.

4. The system of claim 2, wherein the processing device implements an anomaly detection by flagging irregularities in spending behavior of the individual using the locally updated AI model.

5. The system of claim 2, wherein the locally updated AI model includes a reinforcement learning algorithm to classify the individual into a risk category based on the microeconomics finance score determined for the individual.

6. The system of claim 2, wherein the processing device applies a time-weighted risk adjustment algorithm to assign a higher weight to more recent financial events when generating the microeconomics finance score for the individual using the locally updated AI model.

7. The system of claim 2, wherein the processing device generates one or more recommendations for the individual based on the generated microeconomic finance score by using the locally updated AI model.

8. The system of claim 1, wherein the processing device evaluates an individual's long-term financial resilience, adaptive risk scoring, and economic stability to generate resilience-adjusted financial index for the individual using the locally updated AI model.

9. The system of claim 1, wherein the processing device evaluates an individual's spending elasticity, financial adaptability, and systemic economic patterns to generate a microeconomic intelligence score for the individual using the locally updated AI model.

10. The system of claim 1, wherein the processing device evaluates an individual's financial stress signals, early distress markers, and liquidity risk factors to generate a financial stress indicator for the individual using the locally updated AI model.

11. The system of claim 1, wherein the processing device evaluates an individual's financial behavior consistency, responsiveness to AI-driven nudging, and ability to develop long-term financial resilience to generate an AI-powered financial nudging index for the individual using the locally updated AI model.

12. The system of claim 1, wherein the processing device leverages reinforcement learning and behavioral psychology principles to provide personalized financial guidance for an individual using the locally updated AI model.

13. The system of claim 1, wherein the processing device rejects a transaction associated with the real-time high-risk transaction behavior of the customer based on risk assessment using the locally updated AI model.

14. The system of claim 1, wherein the local AI model is trained through a secure multi-party computation to allow to collaboratively compute the local AI model update at the financial institution without the institution's direct access to another institution's data.

15. The system of claim 1, wherein the local AI model is trained by applying a gradient clipping and noise addition at each step of model optimization.

16. The system of claim 1, wherein, prior to transmitting the encrypted local AI model update to the remote server, the processing device adds controlled noise to AI training parameters of the local AI model update.

17. The system of claim 1, wherein the global AI model is trained through homomorphic encryption to ensure encrypted training updates remain secure throughout an aggregation process.

18. The system of claim 1, wherein the global AI model is trained by using a federated averaging algorithm to combine local model updates while reducing discrepancies in AI training across different institutions.

19. The system of claim 1, wherein the global AI model is trained by using one or more of a gradient compression or a secure aggregation to minimize bandwidth usage.

20. A computer-implemented method, comprising:
collecting, by a remote server, raw financial risk data through a processing device of a financial institution, wherein the financial institution does not share the raw financial risk data with other processing devices of a plurality of processing devices;
training, by the processing device, a local AI model of the financial institution based on the raw financial risk data collected by the financial institution, to obtain a local AI model update;
encrypting, by the processing device, the local AI model update and transmitting the encrypted local AI model update to the remote server having a remote central aggregator associated with a global AI model;
receiving, by the remote server, other encrypted local AI model updates from the other processing devices, and training the global AI model based on the encrypted local AI model update from the financial institution and the received other encrypted local AI model updates to generate a global AI model update;
redistributing, by the remote server, the global AI model update to the processing device; and
updating, by the processing device, the locally trained AI model of the financial institution based on the global AI model update,
wherein the processing device detects a real-time high-risk transaction behavior of a customer of the financial institution using the locally updated AI model.
